(19) United States
(12) Patent Application Publication
(10) Pub. No.: US 2009/0277355 A1
(43) Pub. Date: Nov. 12, 2009

(54) ALKENYLSUCCINIC ANHYDRIDE SURFACE-APPLIED SYSTEM AND USES THEREOF

(76) Inventors: Lucyna Pawlowska, Norwalk, CT (US); Kimberly C. Dilts, Beacon Falls, CT (US); Charles R. Hunter, Winchester, VA (US); Michael P. O'Toole, Cheshire, CT (US); Robert J. Proverb, Woodbury, CT (US); Thomas T. Long, Norwalk, CT (US); Gina Garro, Ponte Vedra Beach, CT (US); David L. Dauplaise, Stamford, CT (US); Katarzyna Komarowska, Alpharetta, GA (US); Harold A. Goldsberry, III, Kennesaw, GA (US); Glenn E. Baikow, Allentown, PA (US)

Correspondence Address: CANTOR COLBURN, LLP, 20 Church Street, 22nd Floor, Hartford, CT, 06103, US

(21) Appl. No.: 12/505,578

(22) Filed: Jul. 20, 2009

Related U.S. Application Data
(62) Division of application No. 10/534,202, filed on May 6, 2005, now abandoned.

(30) Foreign Application Priority Data
Dec. 17, 2003 (US) PCT/US03/40272

(51) Int. Cl. C09D 103/02

(52) U.S. Cl. 106/209.1

(57) ABSTRACT

The invention relates to an aqueous sizing composition including: (a) a first component comprising an emulsion having an alkenylsuccinic anhydride component containing alkenylsuccinic anhydride particles and a surfactant component; suspended in water; and (b) a second component selected from the group consisting of cationic starches, non-ionic starches, anionic starches, water, water-soluble polymers, and mixtures thereof; such that the alkenylsuccinic anhydride component and the second component are sufficiently diluted to enable the sizing composition to impart useful sizing properties to a fibrous substrate when the sizing composition contacts the fibrous substrate. The invention also relates to fibrous substrates treated with such a composition as well as processes for making and using the composition. In one embodiment, alkyl ketene dimer is used instead of alkenylsuccinic anhydride.

### BACKGROUND

Papermakers would benefit from a simple, effective, cellulose-reactive surface-applied sizing agent system that (i) imparts useful sizing properties to fibrous substrates and (ii) reduces or eliminates the need to use sizing agents at the wet end of a papermaking process. Unfortunately, known methods and compositions have prevented papermakers from achieving this goal.

It is well known that the property of sizing, as applied to paper, refers to a fibrous substrate's ability to resist wetting or penetration of a liquid into a paper sheet. Aqueous dispersions of alkenylsuccinic anhydride (ASA) cellulose-reactive sizing agent have been widely used in the paper and board making industry for many years, for sizing a wide variety of grades which include printing and writing grades and bleached and unbleached board grades. Cellulose-reactive alkenylsuccinic anhydride emulsions impart hydrophobic properties to the paper and board products.

Chemicals used to achieve sizing properties are known as either internal sizes or surface sizes. Internal sizes can be either rosin-based or synthetic sizes such as alkenylsuccinic anhydride, or other materials. Internal sizes are added to the paper pulp prior to sheet formation. Surface sizes are sizing agents that are added after the paper sheet has formed, most generally at the size press, although spraying applications may also be used.

Alkenylsuccinic anhydride sizing agent is ordinarily applied by dispersing it in a cationic or amphoteric hydrophilic substance such as a starch or a polymer. The starch or polymer-dispersed alkenylsuccinic anhydride sizing emulsions have been added to the pulp slurry before the formation of a paper web. This type of addition of alkenylsuccinic anhydride sizing emulsions to the paper making system is commonly called wet-end addition or internal addition of alkenylsuccinic anhydride.

Unfortunately, the addition of alkenylsuccinic anhydride to the wet end of the papermaking machine has several disadvantages. Internally added alkenylsuccinic anhydride emulsions are never totally retained on the fiber. The portion that is not retained is free to react with water or other components of the paper making system and can form deposits at the wet-end of the paper machine, or can then be carried to the press or drying sections of the paper machine and form paper or board defects.

Further, internal addition of alkenylsuccinic anhydride emulsions has the potential for interacting with other wet-end additives, such as brightening agents, defoamers or dispersants, biocides, dyes, strength agents, etc.

Further, increases in filler addition, such as calcium carbonate filler at the wet-end of the papermaking system have led to an increase in size demand as well. Filler particles have a relatively high surface area as compared to cellulose fiber and readily adsorb internally added sizing agents. Alkenylsuccinic anhydride, which is adsorbed onto calcium carbonate filler particles, leads to less efficient sizing, requiring higher doses as compared to treatment of unfilled paper webs sized with cellulose reacted alkenylsuccinic anhydride sizing agent. Efforts to develop compositions and methods that surface treat fibrous substrates have failed to produce a simple, effective system that imparts useful sizing properties to a fibrous substrate and that reduces or eliminates the need to use sizing agents at the wet end of a papermaking process. For example, conventional surface sizes such as styrene acrylate emulsions, styrene acrylics, styrene, maleic anydrides, polyurethanes and the like require an internal size to be efficient. U.S. Pat. No. 6,162,328 discloses a method for sizing paper that adds a sizing composition containing mixtures of cellulose-reactive and cellulose non-reactive size dispersions to the surface of the paper. The cellulose non-reactive sizes are polymeric materials such as copolymers of styrene or substituted styrenes with vinyl monomers containing carboxyl groups. Cellulose-reactive sizes include sizes such as ketene dimers and multimers, alkenylsuccinic anhydrides, organic epoxides, acyl halides, fatty acid anhydrides from fatty acids and organic isocyanates. The starch may be of any type, including but not limited to oxidized, ethylated, cationic and pearl starch, and is preferably used in aqueous solution. The cellulose-reactive size dispersions and non-reactive size dispersions may be added with a solution of starch or starch derivative before being applied to the paper.

U.S. Pat. No. 6,162,328 requires the combination of at least one cellulose-reactive size and at least one cellulose non-reactive size. This combination allows one to add alkenylsuccinic anhydride or alkylketene dimer to the size press by balancing properties of both types. The requirement that combinations of polymeric materials be used makes the composition more expensive and complicated as compared to single sizing component addition.

U.S. Pat. No. 4,872,951 discloses blends of alkenylsuccinic anhydride-treated and cationic starches for use as external sizes of paper and paperboard products. The blends contain 30-90% (by wt.) of the alkenylsuccinic anhydride-treated starch, which is a monoester of the starch and an alkyl- or alkenylsuccinate and 10-70% (by wt.) cationic starch. The invention requires a reaction product of starch with alkenylsuccinic anhydride combined with cationic starch, which is added to the surface of the paper. Manufacturing this reaction product is an additional process step. WO 02/08514 describes the preparation of a sizing emulsion that contains a sizing agent, and an inorganic, particulate emulsifying agent capable of forming an emulsion and water. The sizing agent can be 2-oxetanone dimer or multimer, alkenylsuccinic anhydride, rosin or carbamoyl chloride. The inorganic particulate emulsifying agent is selected from clay, silica, zeolite, mica, calcium carbonate, phosphate or sulfate; aluminum oxide, hydroxide, phosphate or silicate; magnesium phosphate or silicate; polyaluminum chloride, phosphate or silicate and ferrous or ferric phosphate, silicate or oxide. According to the patent, the addition of the inorganic particulate emulsifying agent allows one to add alkenylsuccinic anhydride to the size press. Example 28, a comparative example, discloses that a conventionally prepared alkenylsuccinic anhydride “emulsion comprising surfactant and starch does not work in the size press . . . .”

U.S. Pat. No. 4,040,900 discloses a method for sizing paper that includes a substituted cyclic dicarboxylic acid anhydride and polyoxyalkylene alkyl or alkylaryl ether or the corresponding mono- or di-ester. The emulsion requires some cationic retention agent to be effective when added to the pulp slurry. The patent discloses that emulsification of the mixture is preferably carried out under conditions in which it is about 25° C. due to the possibility of the hydrolysis of the anhydride. The patent instructs that emulsification “will occur directly in cold water and heating of the water prior to the addition of the sizing mixture is unnecessary and can be even detrimental.” U.S. Pat. No. 4,545,855 reports the use of similar surfactants as U.S. Pat. No. 4,040,900, with higher degrees of ethoxylation in the surfactants. The preferred surfactants are polyethylene glycol diesters. A major drawback of these prior art emulsifiers is the fact that once formed, the succinic anhydride-emulsifier mixtures are unstable and must be promptly used.

U.S. Pat. No. 4,545,856 reports of the preparation of various polyoxyethylene based surfactants that can emulsify alkenylsuccinic anhydride at low shear. The surfactants contain a hydrophobic group, an ethylene oxide group and an acyl capping group. This patent states that surfactants containing hydroxyl groups are not stable in ASA upon storage and need to be capped.

U.S. Pat. Nos. 4,728,366 and 4,832,792 disclose the use of ethoxylated castor oil as a surfactant for low shear emulsification of alkenylsuccinic anhydride. U.S. Pat. Nos. 4,711,671 and 4,747,910 use ethoxylated lanolin as the surfactant. These emulsions are used prior to passing the paper web through the drying section.

U.S. Pat. No. 4,666,523 describes the use of a polyoxyalkylene compound having a terminal hydroxyl group to emulsify alkenylsuccinic anhydride. The tertiary hydroxyl group is used specifically since it has little or no reactivity to ASA. These sizing emulsions are used at the wet end to internally size paper.

U.S. Pat. Nos. 4,695,401, 4,915,786, and 4,849,131 describe the use of a reacted alkenylsuccinic anhydride as a surfactant to emulsify alkenylsuccinic anhydride. A hydrophilic group is reacted onto the alkenylsuccinic anhydride molecule through the anhydride to form an ester, amide, or similar linkage, and a free acid group. This patent requires the additional step of reacting the ASA in order to make the required surfactant.

U.S. Pat. No. 5,759,249 discloses a composition that includes (a) alkenyl succinic anhydride, and (b) about 3% to about 20%, by weight based on the alkenyl succinic anhydride, of an amine selected from the group consisting of trialkyl amine of the formula (I), dimethyl sulfate quaternary salt of trialkyl amine of the formula (I), benzyl chloride quaternary salt of trialkyl amine of the formula (I), and diethyl sulfate

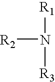

quaternary salt of trialkyl amine of the formula (I), in which R₁ is methyl or ethyl, R₂ is methyl or ethyl, and R₃ is alkyl having 14 to 24 carbon atoms, and wherein said compositions contain about 0.1% water or less. The patent discloses that the emulsification e.g. mixing of its compositions with water is preferably performed using cold water to reduce hydrolysis of the sizing agent e.g. ASA and to reduce the emulsion droplet size (See Col. 6, ll. 35-40). The patent discloses that the emulsification temperature is effective to achieve desired droplet sizes (See Col. 6, ll. 40-41). The patent discloses that the water used for emulsification has a temperature of about 40° C. or less, more preferably about 30° C. or less, even more preferably about 20° C. or less, most preferably about 13° C. or less. (See Col. 6, ll. 40-41). The patent discloses that its sizing emulsion may also be applied directly to a paper web formed from the paper stock, preferably by spraying or by size pressing e.g. applying at the size press. (See Col. 7, ll. 48-49).

The above-mentioned documents are typical of the deficiencies of known art that fail to provide examples or meaningful details that would enable an artisan to practice a simple, effective, cellulose-reactive surface-applied sizing agent system that (i) imparts useful sizing properties to fibrous substrates at conditions typically found in papermaking operations at a temperature that is more than about 40° F., e.g., more than above 120° F. (about 49° C.) or above and (ii) reduces or eliminates the need to use sizing agents at the wet end of a papermaking process. The documents do not disclose systems that would be useful in conditions where hydrolyzed alkenylsuccinic anhydride would be expected to form.

For the foregoing reasons, there is a need to develop a simple, effective, cellulose-reactive surface-applied sizing agent system under ordinary operating conditions that (i) imparts useful sizing properties to fibrous substrates and (ii) reduces or eliminates the need to use sizing agents at the wet end of a papermaking process.

### SUMMARY

The invention relates to an aqueous sizing composition that comprises (a) a first component including an emulsion having an alkenylsuccinic anhydride component containing (i) alkenylsuccinic anhydride particles and (ii) surfactant component; suspended in water; and (b) a second component selected from the group consisting of cationic starches, non-ionic starches, anionic starches, water, water-soluble polymers, and mixtures thereof, such that alkenylsuccinic anhydride component and the second component are sufficiently diluted to enable the sizing composition to impart useful sizing properties to a fibrous substrate when the sizing composition contacts the fibrous substrate.

The invention also relates to an aqueous sizing composition comprising (a) a first component including an emulsion having a first component containing (i) alkyl ketene dimer particles and (ii) surfactant component; suspended in water; and (b) a second component selected from the group consisting of cationic starches, non-ionic starches, anionic starches, water, water-soluble polymers, and mixtures thereof, in which the alkyl ketene dimer component and the second component are sufficiently diluted to enable the sizing composition to impart useful sizing properties to a fibrous substrate when the sizing composition contacts the fibrous substrate.

The invention also relates to fibrous substrates treated with such compositions, methods for making compositions, and methods of using the composition.

These and other features, aspects, and advantages of the present invention will become better understood with reference to the following description and appended claims.

### DESCRIPTION

The invention relates to a sizing composition having an emulsion containing an alkenylsuccinic anhydride component containing particles of alkenylsuccinic anhydride and surfactant suspended in water. The invention also relates to a process for preparing such a composition involving the steps of (a) emulsifying an alkenylsuccinic anhydride component containing a surfactant with water, and thereby forming an emulsion, and (b) combining the emulsion with a second component selected from the group consisting of cationic starches, non-ionic starches, anionic starches, water, water-soluble polymers, or mixtures thereof, and thereby forming the sizing composition. In one embodiment, alkyl ketene dimer is used instead of alkenyl succinic anhydride. In another embodiment, mixtures of alkenylsuccinnic anhydride and alkyl ketene dimer are used.

The invention is based on the remarkable discovery that by emulsifying a first component including alkenylsuccinic anhydride component containing (i) alkenylsuccinic anhydride and (ii) a surfactant component, with water; forming an emulsion, and then combining the emulsion with a second component selected from the group of cationic starches, non-ionic starches, anionic starches, water, water-soluble polymers, and mixtures thereof, under carefully controlled conditions, it is now possible to make a simple, yet highly effective sizing composition that imparts useful sizing properties to a fibrous substrate when the sizing composition is applied at a temperature typically found at a size press.

The invention is also based on the discovery that even if the sizing composition made in accordance to the invention contains hydrolyzed alkenylsuccinic anhydride (HASA), the sizing composition can impart useful sizing properties to fibrous substrates so long as the alkenyl succinic anhydride is sufficiently dilute. Advantageously, the use of the sizing composition reduces or eliminates deposition or sticking at the size press, calendar stack, or drying section of a paper machine. Also, the invention advantageously eliminates the need for starch in the alkenylsuccinic anhydride emulsification step, produces effective sizing compositions with less complicated and less expensive equipment. Utilization of the sizing composition at higher temperatures of the size press is also advantageous.

The phrase “useful sizing properties” as used herein, means sizing properties that are useful for a paper product's intended use. Conversely, the phrase “useless sizing properties” as used herein, means sizing properties that are not useful for a paper product's intended use. The term “emulsion” as used herein refers to emulsions made in accordance with the invention, which when combined with the second component, forms a sizing composition that is particularly useful when applied at any appropriate location in a papermaking process after which a fibrous sheet has formed, e.g., a size press or a coater.

The invention relates to a sizing composition having an emulsion containing an alkenylsuccinic anhydride component containing particles of alkenylsuccinic anhydride and surfactant suspended in water. The invention also relates to a process for preparing such a composition involving the steps of (a) emulsifying an alkenylsuccinic anhydride component containing a surfactant with water, and thereby forming an emulsion, and (b) combining the emulsion with a second component selected from the group consisting of cationic starches, non-ionic starches, anionic starches, water, water-soluble polymers, or mixtures thereof, and thereby forming the sizing composition.

The sizing composition of the invention is specially designed for use at size presses. The sizing composition of this invention reduces or eliminates the need for the use of sizing agents at the wet end of a papermaking process. Of course, the sizing composition of the invention can be used for any other application in which a surface of a fibrous substrate can be treated.

The first component of the sizing composition of the invention includes an emulsion having an alkenylsuccinic anhydride component containing alkenylsuccinic anhydride particles and a surfactant component, suspended in water.

The alkenylsuccinic anhydride component generally includes alkenylsuccinic anhydride compounds composed of mono unsaturated hydrocarbon chains containing pendant succinic anhydride groups. The alkenylsuccinic anhydride compounds are generally liquid and may be derived from maleic anhydride and suitable olefins. The alkenylsuccinic anhydride compounds may be solid.

Generally speaking, the alkenylsuccinic anhydride compounds may be made by reacting an isomerized C₁₄-C₂₀ mono olefin, preferably an excess of an internal olefin, with maleic anhydride, at a temperature and for a time sufficient to form the alkenylsuccinic anhydride compound.

If the olefin to be employed in the preparation of the alkenylsuccinic anhydride compounds is not an internal olefin as is the case for example, with α-olefins, it may be preferable to first isomerize the olefins to provide internal olefins. The olefins that may be used in the preparation of the alkenylsuccinic anhydride compounds may be linear or branched. Preferably, the olefins may contain at least about 14 carbon atoms. Typical structures of alkenylsuccinic anhydride compounds are disclosed, for example, in U.S. Pat. No. 4,040,900, incorporated herein by reference in its entirety. Alkenylsuccinic anhydride compounds and methods for their preparation are described, for example, in C. E. Farley and R. B. Wasser, “The Sizing of Paper, Second Edition,” edited by W. F. Reynolds, TAPPI Press, 1989, pages 51-62, the disclosures of which are hereby incorporated herein by reference in its entirety.

The alkenylsuccinic anhydride component may contain some hydrolyzed alkenylsuccinic anhydride. The amount of hydrolyzed alkenylsuccinic anhydride may range from about 1 to about 99 wt. %, based on the total weight of the alkenylsuccinic anhydride component.

The alkenylsuccinic anhydride component is generally present in the first component in an amount that is at least about 0.1 wt. %, or from about 0.5 to about 70 wt. %, or from about 1 wt. % to about 40 wt. %, based on the total weight of the emulsion comprising the first component.

The emulsion is generally made by emulsifying a suitable amount of alkenylsuccinic anhydride and a surfactant component with a suitable amount of water under conditions that produce an emulsion, which when combined with the second component, forms a sizing composition that imparts useful sizing properties to a fibrous substrate when the sizing composition contacts a fibrous substrate.

The surfactant component includes surfactants, which when used to make an emulsion in accordance with the invention, produces an emulsion that minimizes coalescing and imparts useful sizing properties to a fibrous substrate after the emulsion contacts the fibrous substrate. The surfactant component functions as an emulsifying agent when the surface applied emulsion is made. The surfactant component facilitates the emulsification of the alkenylsuccinic anhydride with the water component when the emulsion is made. Generally, the surfactants are anionic or nonionic or can be cationic and can have a wide range of HLB values.

Examples of suitable surfactants include but are not limited to alkyl and aryl primary, secondary and tertiary amines and their corresponding quaternary salts, sulfosuccinates, fatty acids, ethoxylated fatty acids, fatty alcohols, ethoxylated fatty alcohols, fatty esters, ethoxylated fatty esters, ethoxylated triglycerides, sulfonated amides, sulfonated amines, ethoxylated polymers, propoxylated polymers or ethoxylated/propoxylated copolymers, polyethylene glycols, phosphate esters, phosphonated fatty acid ethoxylates, phosphonated fatty alcohol ethoxylates, and alkyl and aryl sulfonates and sulfates. Examples of preferred suitable surfactants include but are not limited to amides; ethoxylated polymers, propoxylated polymers or ethoxylated/propoxylated copolymers; fatty alcohols, ethoxylated fatty alcohols, fatty esters, carboxylated alcohol or alkylphenol ethoxylates; carboxylic acids; fatty acids; diphenyl sulfonate derivatives; ethoxylated alcohols; ethoxylated fatty alcohols; ethoxylated alkylphenols; ethoxylated amines; ethoxylated amides; ethoxylated aryl phenols; ethoxylated fatty acids; ethoxylated triglycerides; ethoxylated fatty esters; ethoxylated glycol esters; polyethylene glycols; fatty acid esters; glycerol esters; glycol esters; certain lanolin-based derivatives; monoglycerides, diglycerides and derivatives; olefin sulfonates; phosphate esters; phosphorus organic derivatives; phosphonated fatty acid ethoxylates, phosphonated fatty alcohol ethoxylates; polyethylene glycols; polymeric polysaccharides; propoxylated and ethoxylated fatty acids; alkyl and aryl sulfates and sulfonates; ethoxylated alkylphenols; sulfosuccinamates; sulfosuccinates.

In one embodiment, the surfactant component includes an amine selected from the group consisting of trialkyl amine of the formula (I):

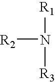

dimethyl sulfate quaternary salt of trialkyl amine of the formula (I), benzyl chloride quaternary salt of trialkyl amine of the formula (I), and diethyl sulfate quaternary salt of trialkyl amine of the formula (I), in which R₁ is methyl or ethyl, R₂ is methyl or ethyl, and R₃ is alkyl having 14 to 24 carbon atoms. In another embodiment, the surfactant excludes this amine.

The surfactant levels can range from about 0.1 weight % up to about 20 weight % based on the alkenylsuccinic anhydride component.

It has been discovered that the following examples do not provide suitable results (produce paper products with useless sizing properties) under certain conditions: sorbitan monolaurate (Arlacel 20), ethoxylated sorbitan trioleate (Tween 85), propoxylated lanolin (Solulan PB-5), ethoxylated lanolin (Laneto 100), sorbitan trioleate (Span 85), Isostearic alkanolamide (Monamid 150-IS), Hydroxylated milk glycerides (Cremophor HMG), Bis(tridecyl) ester of sodium sulfosuccinic acid (Aerosol TR-70).

The particles of the emulsion generally have a median particle size that is about 0.5 microns or higher. The median particle size of the emulsion can vary, depending on the application, the type of surfactant used for emulsification, and the surfactant properties. In one embodiment, the median particle size of the emulsion ranges from about from about 0.1 to about 50 microns, or from about 0.5 to about 30 microns. It will be appreciated that the particles suspended by the water can exhibit a wide range of particle distributions. The ability to use an emulsion having such a wide range of particle distributions is advantageous, because they are easier to prepare. It is generally recognized that emulsions used in wet end applications require relatively narrower and smaller particle size distributions to provide effective sizing. The particle size distribution of the emulsion of this invention is preferably mono-modal. However, in some cases, the distribution can be bimodal or multimodal.

The emulsion is made by passing the alkenylsuccinic anhydride and surfactant and a suitable amount of water through a shearing device that provides sufficient energy to form an emulsion. The alkenylsuccinic anhydride should not be exposed to water before the emulsification process.

The alkenylsuccinic anhydride component is generally present in the sizing composition in an amount that is at least about 0.001 wt. %, or from about 0.05 to about 5 wt. %, or from about 0.1 wt. % to about 3 wt. %, based on the total weight of the sizing composition.

The pressure and temperature at which the emulsion is made are sufficient to make an emulsion that can be combined with the second component and form a sizing composition that imparts useful sizing properties to a fibrous substrate when the sizing composition contacts a fibrous substrate. In one embodiment, the inlet pressure of a suitable emulsification device, e.g., a shearing device, is about 1 psig at a temperature ranging from more than about 40 to about 150, or about 200° F. (4 to about 66° C. or about 94° C.) or from about 120 to about 150°, or about 200° F. and the outlet pressure ranging from about 20 to about 80 psig and preferrably from more than about 40 to about 60 psig at a temperature that ranges from more than about 40 to about 150°, or about 200° F. (from about 4 to about 66° C. or about 94° C.). In one embodiment, the emulsion is made at a temperature that is less than about 40° F., e.g. from about 32° F. to about 40° F.

The primary water flow to a suitable shearing device can range from about 0.1 to about 2.0 gallon per minute (gpm), preferably about 1 gpm. Preferably, the emulsion is made under low shear conditions, e.g. those shearing conditions are created by a device selected from the group of centrifugal pumps, static in-line mixers, peristaltic pumps, magnetic stirring bar in a beaker, overhead stirrer, and combinations thereof.

The second component of the sizing composition of this invention is selected from the group of (i) a starch component (cationic starches, non-ionic starches, anionic starches), (ii) water, (iii) water-soluble polymers, or mixtures thereof, such that the alkenylsuccinic anhydride component in the second component is sufficiently diluted to enable the sizing composition to impart useful sizing properties to a fibrous substrate when the sizing composition contacts the fibrous substrate.

The water-soluble polymers used to make the aqueous sizing composition of this invention include those polymers, which when used in accordance with the invention, produce a sizing composition that imparts useful sizing properties to a fibrous substrate when the sizing composition contacts a fibrous substrate.

Generally, suitable water-soluble polymers of this instant invention are cationic vinyl addition polymers, anionic vinyl addition polymers, neutral polymers, ampholytic polymers and condensation polymers.

Examples of suitable polymers to include, water-soluble polymers having molecular weights ranging from 10,000 daltons to 3,000,000 daltons. The substantially water-soluble polymers to be used in this invention are comprised of but not limited to homopolymers and copolymers, and combinations thereof leading to terpolymers, and tetrapolymers comprised of the following monomers: acrylamide, diallyldimethylammonium chloride, dimethylaminoethylacrylate, dimethylaminoethylacrylate quaternaries, diethylaminoethyl acrylate, diethylaminoethylacrylate quaternaries, dimethylaminoethyl-methacrylate, dimethylaminoethylamethacrylate quaternaries, dimethylaminoethyl-methacrylate and its quaternaries, methacrylamidopropyltrimethyl ammonium chloride, acrylic acid. Suitable polymers also include polymers and copolymers of acrylamide that have been subjected to the “Mannich” reaction. Also, in one embodiment, their corresponding quaternaries are possible water-soluble polymers. Examples of other water-soluble polymers include copolymers comprised of styrene-alkylacrylates, styrene alkylacrylics, styrene maleic acid, styrene-maleic acid amide, styrene maleic acid esters, styrene maleic acid amide ester, and their corresponding salts. In another embodiment, suitable polymers include aqueous dispersions containing combinations of the reaction products of the above monomers, polyurethane dispersions with polyvinyl alcohol, poly (co-vinylalcohol-vinylamine), their corresponding acetates or formamates or partially hydrolyzed polymers, or polyvinylamine.

Examples of copolymers include copolymers of N,N-dialkylamino-alkyl(meth)acrylates and/or amides and/or alkyl (meth)acrylates, styrene, isobutylene, diisobutylene, vinyl acetate and/or acrylonitrile. Examples of condensation polymers include condensation polymers of trimethlyene diamine and 1,2-dichloroethane or 1,3 dichlorpropane; adipic acid with diethylenetriamine, tetraethylenepentamine or similar polyalkylene; polyamides; subsequent reaction products with epichlorohydrin; dimethylamine-epichlorohydrin; ethylenediamine polyacrylamide. Other examples include polyvinyl pyridine, poly-N-methylpyridinium chloride; poly-p-chlorostyrene quaternized with trialkylamine. Examples of such suitable polymers are described in U.S. Pat. Nos. 4,657,946, 4,784,727, 3,445,330, 6,346,554, incorporated herein by reference in their entirety.

Natural polymers, gums, and their extracts included in the embodiments of the invention may be taken from the following list: guar, acacia, agar, algin, carrageenan, cellulose and its derivatives, chitin, chitosan, damar, dextran, dextrin, ethylcellulose, gelatin, gellan, jalap, karaya, kelp, locust bean, methlycellulose, olibanum, pectin, rhamsan, sandarac, tragacanth, welan, and xanthan. This includes the salts and derivatives of the natural polymers. The polymers may be in their natural state or derivatized thereafter to form salts or other derivatives (e.g., hydroxyethylated). The products may be anionic, cationic, amphoteric, or neutral.

The pH of the water-soluble polymer component varies. The preferred pH range of the water-soluble polymer component should be from about 3.0 to about 9.0, most preferably from about 5.0 to about 8.0. The temperature of the water-soluble component can be any temperature, provided that the alkenylsuccinic anhydride component and the second component are sufficiently diluted to enable the sizing composition to impart useful sizing properties to a fibrous substrate when the sizing composition contacts the fibrous substrate. The preferred temperature of the water-soluble polymer component is from more than about 40 to about 150, or about 200° F. (from about 4° C. to about 66° C., or about 94° C.), most preferably from about 55 to about 100° F. (from about 13° C. to about 38° C.).

The water-soluble polymer component is used in an amount that is sufficient to make a sizing composition in accordance with the invention. Generally, the water-soluble polymer component is present in the sizing composition from 0.01 wt % to 20 wt %. In one embodiment, the water-soluble polymer component is generally present in the sizing composition from about 0.05 wt % to about 10 wt %; preferably from 0.075 wt % to about 5 wt %; and most preferably from about 0.1 wt % to about 1 wt %.

The starch component can generally be any starch, which when used in accordance with the invention, produces a sizing composition that imparts useful sizing properties to a fibrous substrate when the sizing composition contacts a fibrous substrate. Generally, the starch component includes starches that have been modified and are generally anionic or non-ionic in nature. However, the starch component can include amphoteric or cationic starches, e.g., starches that are also used in size presses.

Suitable starches are typically anionic or nonionic, and may include those where the base corn, potato, wheat, tapioca or sorghum-based starch is modified through the use of enzymes, high temperatures, and or chemical/thermal converting techniques. Chemical modifications include but are not limited to oxidation, acid modification, heat, acetylation, and hydroxyethylation. Examples of suitable starches include but are not limited to Penford's Douglas® 3012 oxidized dent corn starch, Cargill's Filmflex® 60 hydroxyethylated dent corn starch, Staley's Ethylex® 2035 hydroxyethylated dent corn starch, and Grain Processing Corporation's oxidized dent starch.

The starch can be used in the form of an aqueous starch solution. The viscosity of a starch solution can vary from about 10 cP to about

200 cP at a typical size press solution temperature. The temperature of the starch component can be any temperature, provided that the alkenylsuccinic anhydride component and the second component are sufficiently diluted to enable the sizing composition to impart useful sizing properties to a fibrous substrate when the sizing composition contacts the fibrous substrate. The starch component temperature can vary from about 60 to about 200° F. (from about 15 to about 94° C.). In one embodiment, the temperature of the starch is from more than about 40 to about 150° F. (from about 4 C to about 66° C.) or to about 200 F, or from about 55 to about 100° F. (from about 13° C. to about 38° C.). The starch solids need also not be modified, but can be if desired. The starch solids can range from about 0.1 to about 20 wt. %, and preferably from about 5 to about 13 wt. %. In one embodiment, the pH of the starch component can be used at its autogenous pH. The pH can but does not need to be adjusted. The pH of the starch component is generally from about 5 to 9, or preferably from about 7 to about 8.5.

Water alone is not typically added to emulsions used at a size press. In this invention, however, when water is used as a second component, the water which is typically used in papermaking processes at wet end applications can be used. The water can be added by any suitable means, e.g., a line feed. The preferred pH range of the papermaking water should be from about 4.0 to about 9.0, most preferrably from about 5.0 to about 8.0. The temperature of the water can be any temperature, provided that the alkenylsuccinic anhydride component and the second component are sufficiently diluted to enable the sizing composition to impart useful sizing properties to a fibrous substrate when the sizing composition contacts the fibrous substrate. The preferred temperature of the water should be from more than about 40 to about 150° F. (from about 4° C. to about 66° C.), or about 200° F. most preferrably from about 55 to about 100° F. (from about 13° C. to about 38° C.). Advantageously, when water is used as the second component, the starch component and the water-soluble polymer component do not have to be used in any appreciable amount, preferably none.

Water is the major component of the sizing composition. Generally, the water forms at least about 95 wt. %, or at least about 90 wt. % or at least about 80 wt. % of the sizing composition.

The sizing composition is made by combining the emulsion with the second component (starch, water, or water-soluble polymer). The emulsion can be combined with the second component by any suitable means, e.g., by mixing. Preferably, the emulsion and the second component are combined in-line. When the first component is made at a temperature that is less than about 40° C., the first component is generally heated by the second component when the first component is combined with the second component, such that the temperature of the resulting sizing composition ranges from more than about 40° F., e.g. from more than about 40 to about 200° F. (about 94° C.) or 150° F. (from about 4 C to about 66° C.), or from about 55 to about 100° F. (from about 13° C. to about 38° C.). Alternatively, when the first component is made at a temperature that is more than above about 40° F., the temperature of the resulting aqueous sizing composition is also generally more than above 40° F., e.g. from more than about 40° F., or 50° F. (10° C.) to about 200° F. (about 94° C.). When the first component is made at a temperature that is more than above about 40° F., the temperature of the first component is generally lower than the temperature of the second component. In one embodiment, when the first component is made at a temperature that is more than above about 40° F., the temperature of the first component is the same or greater than the temperature of the second component. As such, the first component is not added directly to a surface of a fibrous substrate, but rather the first component is combined with the second component to form an aqueous sizing composition under conditions that would be expected to cause hydrolysis, and then the resulting sizing composition is added to the fibrous substrate.

In another embodiment, the sizing composition further contains surface sizing agents. However, this is not necessary. Suitable surface sizing agents include but are not limited to styrene maleic anhydride copolymers, styrene acrylic acid copolymers, polyurethane dispersions and styrene acrylate emulsions. Preferred styrene maleic anhydride copolymers are copolymers of styrene or substituted styrene with vinyl monomers such as maleic anhydride and their partially esterified or hydrolyzed counterparts. An example is Baysize® S 48. Preferred styrene acrylic acid copolymers are copolymers of styrene or substituted styrene with vinyl monomers such as acrylic acid and methacrylic acid. Examples are Baysize® S 210 and 225. Preferred polyurethane dispersions are copolymers of isocyanate or diisocyanates and amines or alcohols. Examples are Graphsize™ A, C, and T. Preferred styrene acrylate emulsions are copolymers of styrene, substituted styrene or acrylonitrile with acrylate or methacrylate esters. Examples are Baysize® S AGP, BMP and 850, Basoplast™ 400DS styrene acrylate emulsion. On a dry basis, the ratio of the alkenylsuccinic anhydride component to the additional sizing agent ranges from about 1:0.2 to about 1:50.

In one embodiment, the sizing composition contains less than about 1 to 50 wt. % of an additional sizing agent to the alkenylsuccinic anhydride component. In other embodiments, the sizing composition contains more than about 0.5:1 wt. % additional sizing agent to the alkenylsuccinic anhydride component, or less than about 50:1 wt. % additional sizing agent to the alkenylsuccinic anhydride component.

The fibrous substrate treated with the sizing composition can be any substrate of a paper product, which when treated with the sizing composition made in accordance to the invention, acquires sizing properties that are suitable for its intended use. In one embodiment, the fibrous substrate includes bleached and unbleached paper or paperboard containing calcium carbonate, titanium dioxide, and clay filled paper products. The paper product made from the fibrous substrate may include paper or board, bleached or unbleached, that is treated on the surface in a size press or by spraying with a sizing composition of the invention.

The invention is particularly beneficial for sizing board products, fine paper products, or newsprint paper products. Board is typically a paper machine produced fiber web of heavier weight than fine paper. Generally, the weight of board ranges from about 120 to about 400 grams per square meter, (gsm). Board pulps can be bleached or unbleached virgin softwood, hardwood types or be made of a blend of recycled paper composed of one or more of the following: corrugated boxes, old newsprint, mixed office waste, and old magazines, the latter two containing calcium carbonate filler. Newsprint is essentially wood-containing coated and uncoated magazine and newspaper papers made from ground wood pulp, which is pulp not chemically treated or a combination of ground wood, and recycled furnishes. Fine paper generally is referred to as printing and writing paper, excluding newsprint. Generally, the weight of fine paper ranges from about 40 to about 120 grams per square meter, (gsm). Specific applications include magazines, catalogs, books, commercial printing, copying and business forms, and stationary. The pulp used in the majority of these grades is chemically treated, with limited recycle or wood-containing pulp. Printing and writing paper are generally made from bleached chemical pulps, (e.g., kraft pulping or sulfite pulping), and contain calcium carbonate levels of from about 5 to about 30%. They may also partially contain deinked/recycled bleached waste paper, (sorted mixed office waste).

In use, the invention encompasses a process for sizing a paper product that involves (a) forming a fibrous sheet from a pulp slurry, and (b) treating a surface of the fibrous sheet with the sizing composition of this invention. The sizing composition of the invention is added to a surface of a fibrous substrate at an amount that is sufficiently high to impart useful sizing properties to the resulting paper product. The sizing composition can be added to a fibrous substrate by any way that enables the sizing composition to adsorb onto the surface of the fibrous substrate. The sizing composition penetrates into the fibrous substrate in an amount depended on surface applied starch pick-up. In one embodiment, the sizing composition can be applied to unbleached kraft or wood containing papers. The sizing composition is preferably made on-site and used soon after it is prepared.

In one embodiment, the sizing composition is applied onto the surface of the formed web at an alkenylsuccinic anhydride component dosage (pounds per ton of dry paper) that is at least about 0.1, or from about 0.1 to about 10, or from about 0.5 to about 5, or preferably from about 0.5 to about 3.0. In kilograms per metric ton of dry paper, these dosages correspond to at least about 0.05, or from about 0.05 to about 5, or from about 0.25 to about 2.5, or preferably from about 0.25 to about 1.5. Particularly advantageous dosages of the alkenylsuccinic anhydride component for making board paper products range from about 1.5 to about 3.0, preferably from about 1.5 to about 2.5 pounds per ton of dry paper (from about 0.75 to about 1.5, preferably from about 0.75 to about 1.25 kilograms per metric ton of dry paper).

Particularly advantageous dosages for making fine paper products range from about 0.1 to about 5 pounds per ton of dry paper, or from about 0.5 to about 2.0, or preferably from about 0.5 to about 1.5 pounds per ton of dry paper (from about 0.05 to about 2.5 of dry paper, or from about 0.25 to about 1, or preferably from about 0.25 to about 0.75 kilograms per metric ton of dry paper). Particularly advantageous dosages for making newsprint paper products range from about 0.1 to about 5, from about 0.1 to about 3 or from about 0.1 to about 1.5 pounds per ton of dry paper (from about 0.05, to about 2.5, from about 0.05 to about 1.5 or from about 0.05 to about 0.75 kilograms permetric ton)) Other suitable ranges may from about 0.1 to about 1.0 preferably from about 0.2 to about 0.7 pounds per ton of dry paper (from about 0.05 to about 0.5, preferably from about 0.1 to about 0.35 kilograms per metric ton of dry paper).

Stated in weight percent, the amount of the alkenylsuccinic anhydride component in the fibrous substrate can be at least about

0.005 wt. % and can range from about 0.005 to about 1 wt. %, based on weight of fibrous substrate produced, or preferably from about 0.025 to about 1 wt. % on the same basis.

The temperature at which the sizing composition is used is generally less than than about 180° F. (about 82° C.) or less than about 190° F. (about 88° C.), and can range from about 120° F. (about 49° C.) or from about 40° F. (about 4° C.) to about 180° F. (about 82° C.) or about 190° F. (about 88° C.), or from about 140° F. (about 60° C.) to about 160° F. (about 71° C.). The pH condition in which the sizing composition is used is generally from about 4.0 to about 9, or from about 7 to about 8.

A fibrous substrate treated with a sizing composition of the invention acquires sizing properties that are appropriate for its intended use. Generally, a fine paper product made with the sizing composition will exhibit sizing properties that have at least 20 seconds of ink penetration holdout, as described in TAPPI standard method T530 om96, preferably from about 20 to about 500 seconds, or preferably from about 50 to about 200 seconds.

For board products, the sizing composition is capable of sizing a board fibrous substrate so that the resulting paper product exhibits a Cobb sizing value (based on 2 minute test) ranging from about 50 to about 120 grams per square meter, depending on end use of the board produced. Cobb sizing is a measure of the amount of liquid, generally water, which is adsorbed into the surface of a board or paper sample in a pre-stated amount of time, (in this case 2 minutes) using standardized equipment and procedures as described in TAPPI Method T441 om98. Alternatively, a board paper product made with the sizing composition can exhibit Cobb sizing values ranging from about 30 to about 120 gsm, or preferably from about 50 to about 80 gsm.

For fine paper products, the sizing composition is capable of sizing a fibrous substrate so that the resulting paper product exhibits a Cobb sizing value (based on 1 minute) ranging from about 18 to about 40 gsm. Alternatively, depending on the grade of fine paper, the invention can impart from 20 Seconds Hercules Size Test (HST, also known as “TAPPI 530”, 1% formic acid, 80% reflectance) to 500 seconds of resistance to penetration.

For newsprint paper products, the sizing composition is capable of sizing a fibrous substrate, and producing a resulting paper product that exhibits sizing properties ranging from about 10 to about 100 seconds, as measured by a water drop test (based on 5 μL water drop size), depending on end use of publication grades being made. Water drop test is a commonly used test in newsprint applications where the time for the water drop to penetrate into the fibrous substrate is measured.

Paper products made with the sizing composition of the invention can also contain an internally added sizing agent so that pre-size press sizing has anywhere from about 2 to about 10 seconds of HST for good size press runnability.

When it is desirable to practice a process in which some sizing agent is added to the wet end, a wet end sizing agent component is added to a pulp slurry and a fibrous sheet is formed from the slurry. The fibrous sheet is then treated with a sizing composition of the invention and the fibrous substrate is sized.

The wet end sizing agent component can include any sizing agent that is used in the wet end such as rosin or rosin emulsions and, as such, includes those sizes believed to be capable of forming covalent chemical bonds by reaction with the hydroxyl groups of cellulose. Suitable sizes for use in the wet end sizing agent component include ketene dimers and multimers, alkenylsuccinic anhydrides, organic epoxides containing from about 12 to 22 carbon atoms, acyl halides containing from about 12 to 22 carbon atoms, fatty acid anhydrides from fatty acids containing from about 12 to 22 carbon atoms and organic isocyanates containing from about 12 to 22 carbon atoms. Ketene dimers and multimers are known and described in U.S. Pat. No. 6,162,328, incorporated herein in its entirety.

In one embodiment, the wet end sizing agent contains a cationic component. In another embodiment, the wet end sizing agent contains cationic starch and alkenylsuccinic anhydride. In another embodiment, the wet end sizing agent component contains cationic starch and alkenyl succinic anhydride. In another embodiment, the wet end sizing agent can be the emulsion used to make the sizing composition of the invention. In this embodiment, some emulsion that would ordinarily be used to make the sizing composition of this invention is used for use for the wet end sizing component.

When cellulose-reactive sizing agents are added to the wet end and the sizing composition of the invention is used to surface treat a fibrous substrate, the weight ratio of (i) the sizing agent applied at the wet-end to (ii) the weight ratio of the alkenylsuccinic anhydride component in the sizing composition, is preferably less than about 1:1, or preferably less than about 0.5:1.

Applicants do not understand why, despite subjecting the sizing composition of this invention to conditions which cause rapid hydrolysis of alkenylsuccinic anhydride, the sizing composition imparts useful sizing properties to fibrous substrates. Without being bound by theory, it is believed that the wherein the alkenylsuccinic anhydride component and the second component are sufficiently diluted to enable the sizing composition to impart useful emulsifying and stabilizing properties.

The invention provides previously unavailable advantages. The invention reduces or eliminates the amount of sizing agent used at the wet end, and thereby reduces or eliminates wet end interaction with other chemical additives and furnish components that are known to cause paper machine cleanliness problems. In one embodiment, the alkenylsuccinic anhydride in the wet end sizing agent component is 50% or less of the total alkenylsuccinic anhydride used during an operating period. In another embodiment, the alkenylsuccinic anhydride in the wet end is present in an amount that is 40% or less, or 30% or less, 20% or less or 10% or less of the total cellulose-reactive sizing agents used during an operating period.

The alkenylsuccinic anhydride component contained in the sizing composition, when applied to a surface of a fibrous substrate, is retained in the fibrous substrate at higher levels as compared to when alkenylsuccinic anhydride is added to a pulp slurry.

The invention also enables its user to produce the same amount of paper that would ordinarily be produced by known processes by using less sizing agent. In one embodiment, the invention uses less than 50 percent or from about 70 to about 30 percent less sizing agent that is used in an ordinary process and still produces the same amount of paper without the problems ordinarily encountered with known sizing processes. The invention also provides a system that enables its user to use less amounts of alkenylsuccinic anhydride without sacrificing the quality or amount of paper that is produced at a mill.

Since problems ordinarily encountered with conventional sizing processes are avoided and a higher retention of size is obtained by directly treating a fibrous substrate, it is now possible for papermakers to produce more paper with less sizing agent than they have been accustomed to using. The invention allows papermakers to run papermaking machines for prolonged period of times without problems typically encountered with ordinary sizing compositions, e.g., problems with runnability, deposit formation, or inconsistent quality of paper products. The invention, for instance, allows paper machines to be run for long periods of time without visible deposition to the size press or calendar stack.

The invention is primarily directed to presently preferred embodiments in which the sizing composition of the invention is made with an emulsion containing an alkenylsuccinic anhydride component. The invention, however, also includes embodiments in which the emulsion is made with cellulose-reactive agents other than alkenylsuccinic anhydride. For instance, in one embodiment, the sizing composition can be made with an emulsion containing emulsified cellulose-reactive agents selected from the group consisting of isocyanates, alkyl ketene dimer (AKD) and acid anhydrides.

As such, in one embodiment, the invention can be made or practiced with AKD instead of ASA. As used herein, the term “AKD” refers to alkyl and alkenyl ketene formed into dimers with a chemical structure accepted by those of ordinary skill in the art where AKD contains a hydrophobic group containing more than about 4 carbon atoms and selected from alkyl, alkenyl, aralkyl or aralkenyl groups, as defined above. Preferably, each hydrocarbon group is, independently, a hydrophobic group containing from about 4 carbon atoms to about 36 carbon atoms. AKD sizing agents are described in detail in several references, for example, U.S. Pat. Nos. 3,992,345 and 5,510,003; in J. W. Davis et al., TAPPI 39 (1), 21 (1956); and in R. E. Cates et al., “Alkyl Ketene Dimer Sizes”, Chapter 2 in The Sizing of Paper, 2nd Edition, W. F. Reynolds, Ed., Tappi Press, 1989, pp. 33-50. Specific examples of AKD sizing agents useful in the instant invention include but are not limited to octyl ketene dimer, decyl ketene dimer, dodecyl ketene dimer, tetradecyl ketene dimer, hexadecyl ketene dimer, octadecyl ketene dimer, eicosyl ketene dimer, docosyl ketene dimer, tetracosyl ketene dimer, and those prepared by known methods from organic acids and naturally occurring mixtures of fatty acids such as those found in palmitoleic acid, oleic acid, rincinoleic acid, linoleic acid, linolenic acid, coconut oil, palm oil, olive oil and peanut oil. Mixtures of any of such acids may also be used. Preferred AKD sizing agents include but are not limited to those comprising at least one alkyl or alkenyl group comprising from about 8 to about 36 carbon atoms. More preferred AKD sizing agents include but are not limited to hexadecyl, octadecyl and oleyl ketene dimer. It is understood that the embodiments in which AKD is used instead of ASA, the description of the sizing compositions containing ASA described above (and methods of making and using the compositions) can also be used for sizing compositions in which AKD is used. Accordingly, when the term “alkenylsuccinic anhydride” or “ASA” is used above to describe the invention, the term “AKD” can be also be used instead of the term “alkenylsuccinic anhydride” or “ASA.” In one embodiment, the AKD excludes 2 oxetanone ketene multimer. The invention is further described in the following illustrative examples in which all parts and percentages are by weight unless otherwise indicated.

### EXAMPLES

### Materials, Experimental Procedures, Tests

### Paper Preparation Procedures

The papers used in these examples were prepared from two sources. The first procedure, Paper Preparation A, was made using a pilot paper machine. The furnish was comprised of 30% bleached softwood kraft refined to 420 Canadian Standard Freeness and 70% bleached hardwood kraft refined to 350 Canadian Standard Freeness. An anionic, polyacrylamide retention aid was used in each preparation.

Three papers were prepared. Paper A was a 70 g/m² sheet containing 14.9% calcium carbonate (ALBACAR® 5970, Speciality Minerials Inc) that contained no internal sizing. Paper B was a 70 g/m² sheet containing 14.9% calcium carbonate and pre-determined amounts of added internal size, alkenylsuccinic anhydride (ASA) (BAYSIZE® I 18 synthetic size). Paper C was a 125-g/m² sheet containing 25% calcium carbonate (ALBACAR 5970) and no internal sizing.

Starch sizing emulsions prepared for use in internal addition were made with cationic starch (Hi-Cat® CWS starch, Penford) and Baysize® I 18 internal size at a weight ratio of 1:1, (starch:size) using a Ross Homogenizer. This is called Size Emulsion A.

The second procedure used a commercially available handsheet machine, a standard (8″×8″) Noble and Wood handsheet mold to a target basis weight of 50 lb/TAPPI ream. The typical chemical addition sequence per 10 gram fiber batch at about 0.6% consistency, was: Sizing Agent (if required), mixed for 1 minute, anionic retention aid (about 1 lb/ton), mixed for 15 sec. Each batch was split into three 2.8 dry gram sheets. The sheets were formed, pressed between felts in the nip of a pneumatic roll press at about 15 psig, and drum dried on a rotary drier for about 1 minute at about 2450° F. This is called Paper Preparation B.

### Starch Solutions

A starch solution was prepared by making a 15% starch solids slurry of a commercially available surface size starch (Filmflex® 60 starch, Cargill) in deionized water that has been adjusted to pH 7.0+/−0.2 with either 0.5N HCl or 0.5N NaOH, (hereby referred to as Treated Water A) and heating the mixture to 95° C. for 1 hour. This is called Starch Solution A.

To 150 parts of Starch Solution A were added 171 parts of Treated Water A. Then, 0.5N NaOH solution was added drop-wise to provide a starch solution of pH 7.1-7.3. This is called Starch Solution B.

A starch solution was prepared by making a 15% starch solids slurry of a commercially available surface size starch (StaCote® H44, AE Staley) in Treated Water A and heating the mixture to 95° C. for 1 hour. This is called Starch Solution C.

To 150 parts of Starch Solution C were added 412.5 parts of Treated Water A. Then, 0.5N NaOH solution was added drop-wise to provide a starch solution of pH 7.1-7.3. This is called Starch Solution D.

### Surface Application Procedure A

The appropriate sizing composition was then used to treat paper samples. The desired dosage was calculated based upon the liquid pick-up of the composition on the dry paper sheet. This was determined by measuring the weight difference between the dry sheet and the sheet that has been dipped into the surface treatment solution (and pressed). The test papers were cut to a suitable size, weighed, dipped into the various sizing compositions, pressed at a pressure of 12 psig, and then dried at 240° F. for 35 seconds. The dose levels are reported in lb/ton, i.e., pounds of dry sizing agent per ton of dry paper.

### Surface Application Procedure B

The appropriate paper was produced on the pilot paper machine. At the size press, the appropriate sizing composition was used to treat the paper. The sizing composition was fed to the size press from a run tank, with excess material being recirculated to the run tank. The desired dose was calculated based upon the liquid pick-up of the composition on the dry paper. This is determined by measuring the volume uptake of the starch solution at the size press. The paper was then fed directly into the second drier section and wound at the reel.

### Surface Application Procedure C

A Werner Mathis laboratory size press was adapted for use in flooded-nip, paper size press applications. The laboratory flooded-nip size press consisted of two, hard rubber rollers. The nip pressure between these two rollers was adjusted according to the basis weight of the paper. The speed of rollers was varied to maximize pick-up. Pick-up of the size press solutions was determined by weighing test sheets before and after passing through the nip contain the targeted size press liquid. The test liquids were then dosed with the appropriate amount of treatment solution (real solids based upon dry starch pick-up). Test solutions were added to the nip and the paper sample was fed through the nip. The dose was expressed as pounds of real substrate per ton of dry paper. The treated paper sample was immediately passed through a rotary drum dryer heated at 240° F. for 35 sec.

### Surfactants

The surfactants listed below were tested:

| Surfactant Name | Description | Supplier |
|---|---|---|
| Arlacel ® 20 | Sorbitan Monolaurate | ICI Surfactants |
| Brij ® 78 | Ethoxylated Stearyl Alcohol | Uniqema |
| Brij ® 98 | Ethoxylated Oleyl Alcohol | Uniqema |
| Castor oil | Mixed Fatty acid Glyceride | Aldrich |
| Cremophor ® EL | Ethoxylated Castor Oil | BASF |
| Larostat ® 264 A | Alkyl ammonium quaternary | BASF |
| Span ® 85 | Sorbitan Trioleate | ICI Surfactants |
| Tween ® 85 | Ethoxylated Sorbitan | ICI Surfactants |
| | Trioleate | |
| Aerosol ® OT | Sodium dioctylsulfosuccinate | Cytec Industries |
| Rhodafac ® RS610 | Complex Phosphate Ester | Rhodia |

### Treatment Effectiveness Tests

The treatment effectiveness of the sizing agents and conditions was determined by performing some of the various test described below. The general procedures for these tests are provided below. All paper samples were then conditioned at 50% relative humidity and 70° C. for 24 hours before testing.

### Test A Ink Penetration Holdout

Ink Penetration Holdout was measured using a method similar to that described in TAPPI Method T 530 pm-89 except that an instrument was used as described in U.S. Pat. No. 5,483,078. The test measures the time (in seconds) for the reflectance of the paper on the side opposite that contacting the ink to decreases to 80% of the initial value. The ink consisted of 1.25% Napthol Green B dye buffered to pH 7. The test values were normalized for basis weight of the paper assuming that the values vary as the cube of the basis weight. Results are expressed in units of seconds.

### Image Analysis

Image analysis was performed using an Optomax Sorcerer image analysis system equipped with morphometry application software, a stereo zoom microscope with CCD camera and ring fiber optic illumination. Several types of tests were used.

### Test B Black Image Analysis

A commercially available ink jet printer was used to print onto a test sheet several rows of the letter “H” comprised of bold, 8 point, Arial font. The areas of the four letters were then measured and averaged to provide the “black letter area.” A smaller letter area corresponds to less spreading or wicking of the inked area. Results are expressed in units of mm².

### Test C Color Bleed

Color bleed was determined by measuring the areas of black letters printed on a yellow background, in a similar fashion as described in the Black Image Analysis; a color inkjet printer must be used. Images of four letters were averaged to provide the “letter area.” A smaller letter area corresponds to less spreading or wicking of the inked area. Results are expressed in units of mm².

### Test D Optical Density

Solid, black areas of at least 1-cm² were printed onto the sheet to be tested. The optical density (OD) of the printed areas was measured with a commercially available X-Rite Spectrodensitometer. Values were the average of five measurements. The values are dimensionless. A higher optical density value is generally indicative of improved printability.

### Test E Ultrasonic Attenuation Measurement

This analytical technique records the change in intensity of an ultrasonic signal transmitted through a paper sample while one of its faces was in contact with a liquid. Measurements were made using a Penetration Dynamics Analyzer (PDA) (Emtec Electronic, Gmbh). Two parameters were recorded for these examples. The “A-value” corresponds to liquid absorption into the paper, is a dimensionless number and correlated with the Cobb value (Test I). The “Max” value is characteristic of surface hydrophobicity and was reported in seconds. Typically, three handsheets were tested per treatment with one test per side, felt and wire, for a total of two tests per sheet and six tests per set. These numbers were averaged to provide either the A-value or the Max value for that set.

### Test F Particle Size

Commercially available, light scattering, particle analyzers, Horiba LA-300 and Horiba LA-700, were used to determine the particle size of the emulsions. Results were reported as the median particle size in μm.

### Test G Ring Crush

This test was performed according to TAPPI Test Method T822 pm-84.

### Test H ISO Brightness

This test was performed based on ISO 2469 using TAPPI Test Method T525 om-92 with a Technibrite Eric 950 instrument.

### Test I Water Absorption Cobb Test

This test was performed according to TAPPI Test Method T441 om-90. A two-minute hold time was used.

### Examples 1, 2, 3, 4, 5

Examples 1, 2 and 3 are overviews of the application of reduced shear ASA at the size press in a handsheet and in a pilot machine application. No deposits or runnability issues were encountered. Examples 3, 4 and 5 compare sizing performance of a reduced shear water-emulsified ASA sizing system against a high shear starch-emulsified ASA sizing system.

### Example 1

ASA containing 5% Brij® 98 was emulsified in water with a single impeller, open-faced, centrifugal pump. The low shear centrifugal pump was connected to a tap water supply and the pump was operated using the pressure from the tap water supply. No pH or temperature adjustment was made to the tap water prior to emulsification. The ASA was supplied to the centrifugal pump from a calibration column via a gear pump and entered the water inlet just before the centrifugal pump. The water flow rate was approximately IL/min and the ASA flow rate was approximately 240 mL/min. The centrifugal pump was a single-pass emulsification process with no recirculation. The resulting ASA emulsion contained 19 weight percent ASA.

### Example 2

The sizing emulsion prepared in Example 1 was used to size Paper B by the Paper Preparation A. The emulsion was added to additional Starch Solution B, the second starch component, to make a total sizing composition for paper treatment. The effectiveness of the sizing was determined by Test A Ink Penetration Holdout described above. Emulsion particle size of the emulsion was measured using the Test F Particle Size described above and was 1 μm. The ink penetration results were provided below in Table 1.

TABLE 1

| | | Surface ASA |
|---|---|---|
| | Ink Penetration | Dose |
| Example | (sec) | (lb/ton) |
| Paper B | 47 | — |
| (base sheet) | | |
| 2 | 1008 | 1 |

The results indicate that the low shear emulsification sizing system effectively provides additional sizing to the base sheet.

### Example 3

An emulsion of ASA in water was prepared in a similar manner as Example 1 except that the ASA flow rate was approximately 120 mL/min. The resulting ASA emulsion was 11% ASA concentration.

### Example 4 (Comparative)

The sizing emulsion of this example was prepared in hydroxyethylated dent corn starch (Starch B). The starch pH was 7 and the starch temperature was 30-35° C. The emulsion was prepared in a high shear industrial blender by taking 1429 parts of starch solution and 100 parts of Baysize® S 180 for a 1:1 starch:ASA ratio and a final ASA concentration in the starch of 6.5%.

### Example 5

Sizing emulsions prepared in Examples 3-4 were used to size Paper A by the Paper Preparation A. Each of the emulsions were separately added to additional Starch Solution B, the second starch component, to make a total sizing composition for paper treatment. A dose of 1.5 lb/ton of ASA was delivered to the paper. The effectiveness of the sizing was determined by Test A Ink Penetration Holdout described above. The results were provided below in Table 2.

TABLE 2

| | | Ink | |
|---|---|---|---|
| | | Penetration | Dose |
| Example | Application | (sec) | (lb/ton) |
| 4 | Emulsified in hydroxyethylated | 205 | 1.5 |
| (Comparative) | dent corn starch at 1:1 | | |
| | starch:ASA ratio; final solution | | |
| | starch:size ~70:1 | | |
| 3 | Emulsified at 10.7% | 226 | 1.5 |
| | concentration in water then | | |
| | diluted in hydroxyethylated | | |
| | dent corn starch; final solution | | |
| | starch:size ~70:1 | | |

This comparison shows that the sizing obtained with both ASA emulsions, the reduced shear (Example 3) and the high shear (Example 4) sizing systems provided equivalent ink penetration.

### Examples 6, 7, 8, 9, 10, 11, 12 13, 14

The following examples demonstrate the utility of the instant invention using two different surfactants over a range of surfactant levels in the sizing agent. The surfactants used were Larostat® 264 A (BASF) or Rhodafac® RS610 (Rhodia).

### Example 6

An emulsion used to make a sizing composition in accordance to the invention was prepared as follows. The emulsion was made by adding 10 parts of an ASA component consisting of 95 parts of ASA and 5 parts of Larostat® 264 A to 189.5 parts of water at 25° C. in a household blender and mixing on the low setting for 30 seconds.

### Example 7

An ASA emulsion used to make a sizing composition in accordance to the invention was prepared according to Example 6 except that the ASA component consisted of 90 parts of ASA and 10 parts of Larostat® 264 A.

### Example 8

An ASA emulsion used to make a sizing composition in accordance to the invention was prepared according to Example 6 except that the ASA component consisted of 85 parts of ASA and 15 parts of Larostat® 264 A.

### Example 9

An ASA emulsion used to make a sizing composition in accordance to the invention was prepared according to Example 6 except that the ASA component consisted of 99.9 parts of ASA and 0.1 part of Rhodafac® RS610.

### Example 10

An ASA emulsion used to make a sizing composition in accordance to the invention was prepared according to Example 6 except that the ASA component consisted of 99.5 parts of ASA and 0.5 parts of Rhodafac® RS610.

### Example 11

An ASA emulsion used to make a sizing composition in accordance to the invention was prepared according to Example 6 except that the ASA component consisted of 95 parts of ASA and 5 parts of Rhodafac® RS610.

### Example 12

An ASA emulsion used to make a sizing composition in accordance to the invention was prepared according to Example 6 except that the ASA component consisted of 90 parts of ASA and 10 parts of Rhodafac® RS610.

### Example 13

An ASA emulsion used to make a sizing composition in accordance to the invention was prepared according to Example 6 except that the ASA component consisted of 85 parts of ASA and 15 parts of Rhodafac® RS610.

### Example 14

Sizing emulsions prepared in Examples 6-13 were used to size paper by the Surface Application A. Each of the emulsions were separately added to additional Starch Solution B, the second starch component, to make a total sizing composition for paper treatment. Surface Application A was used to treat Paper A. A dose of 2 lb of sizing agent per ton of paper was used. To 150 g of Starch Solution B was added 4.0 g of the sizing emulsion. The effectiveness of the sizing was determined by Test A Ink Penetration Holdout described above. Emulsion particle size for each of the emulsions was measured using the Test F Particle Size described above. The results were provided below in Table 3.

TABLE 3

| Example | Particle Size (microns) | Ink Penetration (sec) |
|---|---|---|
| 6 | 1.710 | 174 |
| 7 | 1.150 | 204 |
| 8 | 1.150 | 156 |
| 9 | 2.804 | 55 |
| 10 | 2.101 | 139 |
| 11 | 1.222 | 203 |
| 12 | 1.230 | 211 |
| 13 | 1.042 | 162 |

From these data we conclude that both effective particle size and ink penetration holdout is achieved when using the above mentioned surfactants in the amounts described in this instant invention.

### Examples 15 to 19

The following Examples show the influence of the concentration of alkenylsuccinic anhydride in the emulsion and printing performance.

### Example 15

An emulsion used to make a sizing composition in accordance to the invention was prepared as follows. To a household blender was added 99.0 parts of Treated Water A. The speed of the blender was set to low. Into the vortex was added 0.9 parts of alkenylsuccinic anhydride and 0.1 parts of Brij® 78 called Surfactant B and held for 30 seconds.

### Example 16

An emulsion used to make a sizing composition in accordance to the invention was prepared as follows. The procedure of Example 15 was repeated except 95.0 parts of Treated Water, 4.5 parts of ASA, 0.5 parts of Surfactant B were used.

### Example 17

An emulsion used to make a sizing composition in accordance to the invention was prepared as follows. The procedure of Example 15 was repeated except 90.0 parts of Treated Water, 9.0 parts of ASA, 1.0 part of Surfactant B were used.

### Example 18

An emulsion used to make a sizing composition in accordance to the invention was prepared as follows. The procedure of Example 15 was repeated except 85.0 parts of Treated Water, 13.5 parts of ASA, 1.5 parts of Surfactant B were used.

### Example 19

Sizing emulsions prepared in Examples 15 through 18 were used to size paper by the Surface Application Procedure A to treat Paper C. Each of the emulsions was added to Starch Solution A.

For comparison purposes, Paper C was treated with Starch Solution A using Surface Application Procedure A.

The effectiveness of the treatment for Examples 15-18 was determined by printing the treated sheets on a commercial ink jet printer and measuring the performance with the tests for Ink Penetration (Test A), Color Bleed (Test C), and Black Image Area (Test B). The results are shown in Table 4.

TABLE 4

| | | | | | Black |
|---|---|---|---|---|---|
| | | | Ink | Color | Image |
| | ASA | Dose | Penetration | Bleed | Area |
| Example | (%) | (lb/ton) | (sec) | (mm²) | (mm²) |
| Paper C | 0 | 0 | 0 | 2.533 | 2.466 |
| Starch | 0 | 0 | 0 | 2.565 | 2.543 |
| blank | | | | | |
| 15 | 1 | 2.5 | 19 | 2.067 | 2.157 |
| 16 | 5 | 2.5 | 23 | 2.084 | 2.147 |
| 17 | 10 | 2.5 | 23 | 2.04 | 2.126 |
| 18 | 15 | 2.5 | 21 | 2.05 | 2.157 |

### Examples 20 to 25

The following Examples support the influence of surfactant concentration on sizing and print quality performance.

### Example 20

An emulsion used to make a sizing composition in accordance to the invention was prepared as follows. To a beaker with magnetic stirring was added 82.0 parts of Treated Water A. Into the vortex was added 17.973 parts of alkenylsuccinic anhydride and 0.027 part of Surfactant B and held for 30 seconds.

### Example 21

An emulsion used to make a sizing composition in accordance to the invention was prepared as follows. To a household blender is added 90.0 parts of Treated Water A. The stirrer is set at low and into the vortex is added in one portion 9.9 parts of ASA and 0.1 part of Surfactant B. The stirring is continued for 30 seconds.

### Example 22

An emulsion used to make a sizing composition in accordance to the invention was prepared as follows. The procedure of Example 21 was repeated except 90.0 parts of Treated Water, 9.5 parts of ASA, 0.5 parts of Surfactant B were used.

### Example 23

An emulsion used to make a sizing composition in accordance to the invention was prepared as follows. The procedure of Example 21 was repeated except 99.0 parts of Treated Water, 0.95 parts of ASA, 0.05 parts of Surfactant B were used.

### Example 24

An emulsion used to make a sizing composition in accordance to the invention was prepared as follows. The procedure of Example 21 was repeated except 90.0 parts of Treated Water, 8.5 parts of ASA, 1.5 parts of Surfactant B were used.

### Example 25

Sizing emulsions prepared in Examples 20 through 24 were used to size paper by the Surface Application Procedure A to treat Paper C. Each of the emulsions was added to Starch Solution A.

For Examples 20 and 21, Paper C was treated with Starch Solution A using Surface Application Procedure A for use as a control.

Separately, for Examples 22-24, Paper C was treated with Starch Solution A using Surface Application Procedure A for use as a control.

The effectiveness of sizing in these two studies was determined by printing the treated sheets on a commercial printer and measuring the performance with the tests for Ink Penetration (Test A), Color Bleed (Test C), Black Image Area (Test B), and Ultrasonic Attenuation Measurement (Test E). The results are shown in Table 5.

TABLE 5

| | | | Ink | | Black | |
|---|---|---|---|---|---|---|
| | % | | Pene- | Color | Image | PDA |
| | Surfactant | Dose | tration | Bleed | Analysis | (A |
| Example | in ASA | (lb/ton) | (sec) | (mm²) | (mm²) | value) |
| Paper C | — | 0 | 0 | 2.500 | 2.463 | 38.9 |
| Starch | — | 0 | 0 | 2.497 | 2.490 | 39.4 |
| only | | | | | | |
| 20 | 0.15 | 10 | 9 | 1.966 | 2.027 | 34.4 |
| 21 | 1 | 4.5 | 26 | 2.065 | 1.989 | 34.9 |
| Paper C | — | 0 | 0 | 2.533 | 2.466 | — |
| Starch | — | 0 | 0 | 2.565 | 2.543 | — |
| only | | | | | | |
| 22 | 5 | 2.5 | 12 | 2.064 | 2.175 | — |
| 23 | 5 | 2.5 | 21 | 2.087 | 2.162 | — |
| 24 | 15 | 2.5 | 12 | 2.051 | 2.136 | — |

These examples show that over a wide range of surfactant to ASA level, effective sizing properties can be achieved.

### Examples 26 to 31

The following Examples show sizing compositions having different particle distributions.

### Example 26

An emulsion used to make a sizing composition in accordance to the invention was prepared as follows. To a household blender was added 95.0 parts of Treated Water A. The speed of the blender was set to low. Into the vortex were added 4.25 parts of alkenylsuccinic anhydride and 0.75 parts of Surfactant B, the stirring continued for 30 seconds.

### Example 27

An emulsion used to make a sizing composition in accordance to the invention was prepared as follows. The procedure of Example 26 was repeated except 4.75 parts of ASA and 0.25 parts of Surfactant B were used.

### Example 28

An emulsion used to make a sizing composition in accordance to the invention was prepared as follows. The procedure of Example 26 was repeated except 85.0 parts of Treated Water, 14.25 parts of ASA and 0.75 part of Surfactant B were used and the stirring continued for 15 seconds.

### Example 29

An emulsion used to make a sizing composition in accordance to the invention was prepared as follows. The procedure of Example 26 was repeated except 85.0 parts of Treated Water, 14.85 parts of ASA and 0.15 parts of Surfactant B were used.

### Example 30

An emulsion used to make a sizing composition in accordance to the invention was prepared as follows. The procedure of Example 26 was repeated except 82.0 parts of Treated Water, 17.973 parts of ASA and 0.027 parts of Surfactant B were used and the stirring continued for 5 seconds.

### Example 31

Sizing compositions were made with the sizing emulsions prepared in Examples 26 through 30. Sizing emulsions prepared in Examples 26 through 30 were used to size paper by the Surface Application Procedure A to treat Paper C. Each of the emulsions was added to Starch Solution A.

Separately, for Examples 28-30, Paper C was treated with Starch Solution A using Surface Application Procedure A for use as a control.

The effectiveness of sizing was determined by printing the treated sheets on a commercial printer and measuring the performance using tests: Ink Penetration (Test A), Color Bleed (Test C), Black Image Analysis (Test B), and Ultrasonic Attenuation Measurement (Test E). The results are shown in Table 6.

TABLE 6

| | | | | | | Black | |
|---|---|---|---|---|---|---|---|
| | | Particle | | Ink | Color | Image | PDA |
| | Dose | Size | Emulsion | Penetration | Bleed | Analysis | A- |
| Example | (lb/ton) | (μm) | Modality | (sec) | (mm²) | (mm²) | Value |
| Paper C | 0 | n/a | | 0 | 2.533 | 2.466 | — |
| Starch | 0 | n/a | | 0 | 2.565 | 2.543 | — |
| only | | | | | | | |
| 26 | 3 | 0.57 | monomodal | 17 | 2.065 | 2.158 | — |
| 27 | 2.5 | 1.40 | monomodal | 18 | 2.077 | 2.152 | — |
| Paper C | 0 | n/a | | 0 | 2.500 | 2.463 | 38.9 |
| Starch | 0 | n/a | | 0 | 2.497 | 2.490 | 39.4 |
| only | | | | | | | |
| 28 | 8 | 3.01 | bimodal | 78 | 1.956 | 2.041 | 26.0 |
| 29 | 5 | 5.24 | bimodal | 24 | 1.979 | 2.061 | 36.0 |
| 30 | 7 | 9.37 | trimodal | 16 | 1.966 | 2.104 | 35.9 |

These examples show that over a wide range in particle size and modality, effective sizing properties can be achieved.

### Comparative Examples 32, 33, 34, 35

The following Examples 32-35 show the influence of the type and the amount of surfactant on the quality of the reduced shear ASA emulsion.

### Comparative Example 32

An emulsion used to make a sizing composition in accordance to the invention was prepared as follows. The emulsion was made by adding 0.5 parts of an ASA component consisting of 95 parts of ASA and 5 parts of Span 85 to 49.5 parts of water that was pH adjusted to 4.2 with dilute sulfuric acid in a household blender and mixing on the low setting for 30 seconds.

### Comparative Example 33

An ASA emulsion used to make a sizing composition in accordance to the invention was prepared according to Example 32 except that the ASA component consisted of 95 parts of ASA and 5 parts of Tween 85.

### Comparative Example 34

The emulsion stability was determined visually and the data was reported in Table 7 below.

TABLE 7

| Example | Particle Size (microns) |
|---|---|
| 32 (Comparative | Emulsion Separated |
| | Immediately |
| 33 (Comparative) | Emulsion Separated |
| | Immediately |

From these data we conclude that some classes of surfactants do not provide suitable ASA emulsions.

### Comparative Example 35

An emulsion used to make a sizing composition in accordance to the invention was prepared as follows. The emulsion was made by adding 0.5 parts of an ASA component consisting of 95 parts of ASA and 5 parts of Arlacel 20 to 49.5 parts of waterthat was pH adjusted to 4.5 with dilute sulfuric acid in a household blender and mixing on the low setting for 1 minute.

### Comparative Example 36

An ASA emulsion used to make a sizing composition in accordance to the invention was prepared according to Example 35 except that the ASA component consisted of 95 parts of ASA and 5 parts of Tween 85.

### Comparative Example 37

The emulsion stability was determined visually and the data was reported in Table 8 below.

TABLE 8

| Example | Particle Size (microns) |
|---|---|
| 35 (Comparative | Emulsion Separated |
| | Immediately |
| 36 (Comparative) | Emulsion Separated |
| | Immediately |

From these data we can see that not all surfactants fall within the scope of this instant invention.

### Examples 38, 39, 40, 41, 42

These Examples show the influence of strength resins on sizing performance using a reduced shear sizing system of this invention.

### Example 38

An emulsion used to make a sizing composition in accordance to the invention was prepared as follows. The emulsion was made by adding 3.09 parts of an ASA component consisting of 97 parts of ASA and 3 parts of Brij 98 to 96.1 parts of water in a household blender and mixing on the low setting for 1 minute.

### Example 39

Sizing emulsion prepared in Example 38 was used to size paper by the Surface Application A. The 3.75 parts of the emulsion was separately added to 300 parts additional Starch Solution D, the second starch component, to make a total sizing composition for paper treatment. Surface Application A was used to treat Paper B. The effectiveness of the sizing and strength were determined by Test A Ink Penetration Holdout and Test G Ring Crush described above. The data was reported in Table 9 below.

### Example 40

Sizing emulsion prepared in Example 38 and an anionic polyacrylamide strength resin, Baystrength® FP 200 (Bayer Chemicals Corporation), were used to size paper by the Surface Application A. The 3.75 parts emulsion and the 6.75 parts strength resin were separately added to 300 parts additional Starch Solution D, the second starch component, to make a total sizing composition for paper treatment. Surface Application A was used to treat Paper B. The effectiveness of the sizing and strength were determined by Test A Ink Penetration Holdout and Test G Ring Crush described above. The data was reported in Table 9 below.

### Example 41

Sizing emulsion prepared in Example 38 and an anionic polyacrylamide strength resin, Baystrength® FP 100, (Bayer Chemicals Corporation), were used to size paper by the Surface Application A. The 3.75 parts emulsion and the 6.75 parts strength resin were separately added to 300 parts additional Starch Solution D, the second starch component, to make a total sizing composition for paper treatment. Surface Application A was used to treat Paper B. The effectiveness of the sizing and strength were determined by Test A Ink Penetration Holdout and Test G Ring Crush described above. The data was reported in Table 9 below.

### Example 42

Base Sheet Paper B was surface sized with 300 parts Starch Solution D. Surface Application A was used to treat Paper B. The effectiveness of the sizing and strength were determined by Test A Ink Penetration Holdout and Test G Ring Crush described above. The data was reported in Table 9 below.

TABLE 9

| Example | Ink Penetraton (sec) | Ring Crush (lb/in) |
|---|---|---|
| 39 | 180 | 14.32 |
| 40 | 339 | 15.16 |
| 41 | 261 | 15.56 |
| 42 | 18 | 12.93 |

From the data we conclude that the use of strength agents with the instant invention has minimum influence on sizing and strength properties are expressed.

### Examples 43, 44, 45

The following Examples illustrate the influence of optical brighteners and conductivity on the performance of the instant invention.

### Example 43

An emulsion was prepared using a centrifugal pump. Tap water was used without pH adjustment. The pH was 8.1 and the conductivity was 178 μS/cm @22° C. The water flow was approximately 1 L/minute. The centrifugal pump was run at 1700 rpm using the ambient tap water pressure. The ASA component consisted of 97 parts of ASA and 3 parts of Brij 98 and was delivered to the centrifugal pump from a calibration column with a flow of approximately 120 mL/minute. The resulting ASA concentration in the water was 10.7%.

### Example 44

Sizing emulsion prepared in Example 43 was used to size Paper A prepared on a pilot paper machine by dosing 3 lbs of the emulsion per ton of dry paper pulp to Starch Solution C, the second starch component, to make a total sizing composition in the size press run tank. In addition, sodium chloride at a dose of 15 lb per ton of dry paper pulp and Blankophor® P150, an optical brightener at a dose of 10 lb per ton of dry paper pulp were added to the size press. The appropriate dosage delivered to the paper machine for each additive was based on the starch pick-up.

The effectiveness of the sizing and brightness were determined by Test A Ink Penetration Holdout and Test H ISO Brightness described above. The data was reported in Table 10 below.

### Example 45

Starch Solution C with no other size press additives was run in the size press run tank as a control. The data was reported in Table 10 below.

TABLE 10

| | ISO Brightness | Ink Penetration |
|---|---|---|
| Example | (% Reflectance) | (Sec) |
| 44 | 90.65 | 196 |
| 45 | 85.95 | 0 |

From these data, we conclude that the use of electrolytes and optical brighteners do not impact the sizing development of the instant invention.

### Examples 46-61

These Examples show the use of the instant invention in furnishes prepared in high and low conductivity environments. Also, these Examples show the benefit of the instant invention applied on the surface as compared to wet-end addition of ASA and wet-end addition of AKD.

### Comparative Example 46

Recycled pulp from a local mill was obtained for these examples. The furnish was mostly mixed office waste with some old corrugated container. A solution of calcium chloride and sodium sulfate (weight ratio of 5:8, respectively) was used to adjust the furnish mixture to achieve a low conductivity of 1500 μS/cm. Handsheets had a basis weight of 27 lb per 1000 ft² was targeted and a cationic polyacrylamide retention aid was used at a dose of 1 lb per ton of dry paper pulp.

To the furnish was added a commercial sample of AKD called Sizing Agent C in quantities sufficient to provide a dose of 4 pounds of sizing agent per ton of dry paper.

### Comparative Example 47

Handsheets were prepared as described in Example 46. To the furnish was added Sizing Agent C in quantities sufficient to provide a dose of 5 pounds of sizing agent per ton of dry paper.

### Comparative Example 48

Handsheets were prepared as described in Example 46. To the furnish was added Sizing Agent C in quantities sufficient to provide a dose of 6 pounds of sizing agent per ton of dry paper.

### Comparative Example 49

Cationic potato starch (StaLok® 400, AE Staley) was cooked as a 15% starch slurry in Treated Water A at 95° C. for 1 hour. The resultant solution was diluted to 4% solids with Treated Water A. This was Starch Solution E. Handsheets were prepared as described in Example 46 except for the addition of starch. To the furnish was added Sizing Agent C in quantities sufficient to provide a dose of 4 pounds per ton of dry paper and Starch Solution E was added in sufficient quantities to provide an active size to active starch ratio of 1:1.

### Comparative Example 50

Handsheets were prepared as described in Example 46 except for the addition of starch. To the furnish was added Sizing Agent C in quantities sufficient to provide a dose of 5 pounds per ton of dry paper and Starch Solution E was added in sufficient quantities to provide an active size to active starch ratio of 1:1.

### Comparative Example 51

Handsheets were prepared as described in Example 46 except for the addition of starch. To the furnish was added Sizing Agent C in quantities sufficient to provide a dose of 6 pounds per ton of dry paper and Starch Solution E was added in sufficient quantities to provide an active size to active starch ratio of 1:1.

### Comparative Example 52

To an industrial blender was added 190 parts of Starch Solution E, and the solution was stirred at the low setting. To the vortex, was added in one portion, 7.6 parts of a commercial sample of ASA (Baysize® I 18, Bayer Chemicals). The speed was then changed to high, and maintained for 3 minutes. This solution was then diluted with Treated Water A such that the concentration of active sizing agent was 0.5%. This was called Sizing Agent D.

Handsheets were prepared as described in Example 46 except ASA was substituted for AKD. To the furnish was added Sizing Agent D in quantities sufficient to provide a dose of 4 pounds per ton of dry paper.

### Comparative Example 53

Handsheets were prepared as described in Example 52 except to the furnish was added Sizing Agent D in quantities sufficient to provide a dose of 5 pounds per ton of dry paper.

### Comparative Example 54

Handsheets were prepared as described in Example 52 except to the furnish was added Sizing Agent D in quantities sufficient to provide a dose of 6 pounds per ton of dry paper.

### Additive A

A solution of commercial alum was diluted to 0.5% with Treated Water A. This was Additive A.

### Comparative Example 55

Handsheets were prepared as described in Example 52 except for the addition of alum. To the furnish was added Sizing Agent D in quantities sufficient to provide a dose of 4 pounds per ton of dry paper and Additive A in sufficient quantities to provide a dose of 5 pounds per ton of dry paper.

### Comparative Example 56

Handsheets were prepared as described in Example 52 except for the addition of alum. To the furnish was added Sizing Agent D in quantities sufficient to provide a dose of 5 pounds per ton of dry paper and Additive A in sufficient quantities to provide a dose of 5 pounds per ton of dry paper.

### Comparative Example 57

Handsheets were prepared as described in Example 52 except for the addition of alum. To the furnish was added Sizing Agent D in quantities sufficient to provide a dose of 6 pounds per ton of dry paper and Additive A in sufficient quantities to provide a dose of 5 pounds per ton of dry paper.

### Example 58

Additional handsheets were prepared as described in Example 46 except no wet-end size was added. Sizing Agent E was prepared using Emulsion Procedure A, except that 5 parts of Brij® 98 was used.

Handsheets were treated with a mixture of Sizing Agent E and Starch Solution C using Surface Application Procedure A. Sizing Agent E was added in quantities sufficient to provide a dose of 1.5 pounds of sizing agent per pound of dry fiber.

### Example 59

Handsheets were treated like Example 58. Sizing Agent E was added in quantities sufficient to provide a dose of 2 pounds of sizing agent per pound of dry fiber E and Starch Solution C was added using Surface Application Procedure A.

### Example 60

Handsheets were treated like Example 58. Sizing Agent E was added in quantities sufficient to provide a dose of 3 pounds of sizing agent per pound of dry fiber E and Starch Solution C was added using Surface Application Procedure A.

### Example 61

Handsheets were treated like Example 58. Sizing Agent E was added in quantities sufficient to provide a dose of 4 pounds of sizing agent per pound of dry fiber E and Starch Solution C was added using Surface Application Procedure A.

Examples 46-61 were analyzed for sizing using a 2-minute Cobb test, Test I. These results are reported in Table 11.

TABLE 11

| | | Cobb (gsm) | | | | | |
|---|---|---|---|---|---|---|---|
| | | Dose (lb/tn) | | | | | |
| Examples | | 1.5 | 2 | 3 | 4 | 5 | 6 |
| Comparative 46 | W/E AKD | | | | 204 | | |
| Comparative 47 | W/E AKD | | | | | 194 | |
| Comparative 48 | W/E AKD | | | | | | 134 |
| Comparative 49 | W/E AKD w/ | | | | 202 | | |
| | starch | | | | | | |
| Comparative 50 | W/E AKD w/ | | | | | 146 | |
| | starch | | | | | | |
| Comparative 51 | W/E AKD w/ | | | | | | 82 |
| | starch | | | | | | |
| Comparative 52 | W/E ASA | | | | 222 | | |
| Comparative 53 | W/E ASA | | | | | 177 | |
| Comparative 54 | W/E ASA | | | | | | 96 |
| Comparative 55 | W/E ASA | | | | 203 | | |
| | w/ alum | | | | | | |
| Comparative 56 | W/E ASA | | | | | 165 | |
| | w/ alum | | | | | | |
| Comparative 57 | W/E ASA | | | | | | 72 |
| | w/ alum | | | | | | |
| 58 | ASA at surface | 106 | | | | | |
| 59 | ASA at surface | | 38 | | | | |
| 60 | ASA at surface | | | 31 | | | |
| 61 | ASA at surface | | | | 28 | | |

From these data, we show that the sizing agent of this instant invention had superior performance to the comparative wet end sizing examples and was not influenced by low conductivity papermaking conditions and provides improved water adsorption holdout efficiency versus conventional synthetic sizes.

### Comparative Example 62

Recycled pulp from a local mill was obtained for these examples. The furnish was mostly mixed office waste with some old corrugated container. A solution of calcium chloride and sodium sulfate (weight ratio of 5:8, respectively) was used to adjust the furnish mixture to achieve a high conductivity of 5,000 μS/cm. Handsheets were prepared that had a basis weight of 27 lb per 1000 ft² and a cationic polyacrylamide retention aid was used at a dose of 1 lb per ton of dry paper pulp.

To the furnish was added Sizing Agent C in quantities sufficient to provide a dose of 4 pounds of sizing agent per ton of dry paper.

### Comparative Example 63

Handsheets were prepared as described in Example 62. To the furnish was added Sizing Agent C in quantities sufficient to provide a dose of 5 pounds of sizing agent per ton of dry paper.

### Comparative Example 64

Handsheets were prepared as described in Example 62. To the furnish was added Sizing Agent C in quantities sufficient to provide a dose of 6 pounds of sizing agent per ton of dry paper.

### Comparative Example 65

Handsheets were prepared as described in Example 62 except for the addition of starch. The cationic starch was cooked like Comparative Example 51. To the furnish was added Sizing Agent C in quantities sufficient to provide a dose of 4 pounds per ton of dry paper and Starch Solution E in sufficient quantities to provide an active size to active starch ratio of 1:1.

### Comparative Example 66

Handsheets were prepared as described in Example 65. To the furnish was added Sizing Agent C in quantities sufficient to provide a dose of 5 pounds per ton of dry paper and Starch Solution E in sufficient quantities to provide an active size to active starch ratio of 1:1.

### Comparative Example 67

Handsheets were prepared as described in Example 65. To the furnish was added Sizing Agent C in quantities sufficient to provide a dose of 6 pounds per ton of dry paper and Starch Solution E in sufficient quantities to provide an active size to active starch ratio of 1:1.

### Comparative Example 68

Handsheets were prepared as described in Example 62 except ASA was substituted for AKD. To the furnish was added Sizing Agent D in quantities sufficient to provide a dose of 4 pounds per ton of dry paper.

### Comparative Example 69

Handsheets were prepared as described in Example 68. To the furnish was added Sizing Agent D in quantities sufficient to provide a dose of 5 pounds per ton of dry paper.

### Comparative Example 70

Handsheets were prepared as described in Example 68. To the furnish was added Sizing Agent D in quantities sufficient to provide a dose of 6 pounds per ton of dry paper.

### Comparative Example 71

Handsheets were prepared as described in Example 68 except for the addition of alum. To the furnish was added Sizing Agent D in quantities sufficient to provide a dose of 4 pounds per ton of dry paper and Additive A in sufficient quantities to provide a dose of 5 pounds per ton of dry paper.

### Comparative Example 72

Handsheets were prepared as described in Example 71. To the furnish was added Sizing Agent D in quantities sufficient to provide a dose of 5 pounds per ton of dry paper and Additive A in sufficient quantities to provide a dose of 5 pounds per ton of dry paper.

### Comparative Example 73

Handsheets were prepared as described in Example 71. To the furnish was added Sizing Agent D in quantities sufficient to provide a dose of 6 pounds per ton of dry paper and Additive A in sufficient quantities to provide a dose of 5 pounds per ton of dry paper.

### Example 74

Additional handsheets were prepared using the pulp described in Example 62 except no wet-end size was added. Sizing Agent E was prepared using Emulsion Procedure A, except that Brij 98 was used.

Handsheets were treated with Sizing Agent E and Starch Solution C using Surface Application Procedure A. Sizing Agent E was added in quantities sufficient to provide a dose of 1.5 pounds of sizing agent per pound of dry fiber.

### Example 75

Handsheets prepared like Example 74 were treated with Sizing Agent E and Starch Solution C using Surface Application Procedure A. Sizing Agent E was added in quantities sufficient to provide a dose of 2 pounds of sizing agent per pound of dry fiber.

### Example 76

Handsheets prepared like Example 74 were treated with Sizing Agent E and Starch Solution C using Surface Application Procedure A. Sizing Agent E was added in quantities sufficient to provide a dose of 3 pounds of sizing agent per pound of dry fiber.

### Example 77

Handsheets prepared like Example 74 were treated with Sizing Agent E and Starch Solution C using Surface Application Procedure A. Sizing Agent E was added in quantities sufficient to provide a dose of 4 pounds of sizing agent per pound of dry fiber.

Examples 62-77 were analyzed for sizing using a 2-minute Cobb test, Test I. These results are reported in Table 12.

TABLE 12

| | | Cobb (gsm) | | | | | |
|---|---|---|---|---|---|---|---|
| | | Dose (lb/tn) | | | | | |
| Examples | | 1.5 | 2 | 3 | 4 | 5 | 6 |
| Comparative 62 | W/E AKD | | | | 190 | | |
| Comparative 63 | W/E AKD | | | | | 156 | |
| Comparative 64 | W/E AKD | | | | | | 84 |
| Comparative 65 | W/E AKD w/ | | | | 198 | | |
| | starch | | | | | | |
| Comparative 66 | W/E AKD w/ | | | | | 157 | |
| | starch | | | | | | |
| Comparative 67 | W/E AKD w/ | | | | | | 83 |
| | starch | | | | | | |
| Comparative 68 | W/E ASA | | | | 171 | | |
| Comparative 69 | W/E ASA | | | | | 68 | |
| Comparative 70 | W/E ASA | | | | | | 37 |
| Comparative 71 | W/E ASA w/ | | | | 176 | | |
| | alum | | | | | | |
| Comparative 72 | W/E ASA w/ | | | | | 80 | |
| | alum | | | | | | |
| Comparative 73 | W/E ASA w/ | | | | | | 41 |
| | alum | | | | | | |
| 74 | ASA at surface | 143 | | | | | |
| 75 | ASA at surface | | 37 | | | | |
| 76 | ASA at surface | | | 31 | | | |
| 77 | ASA at surface | | | | 28 | | |

From the data, we conclude that high conductivity papermaking conditions have little meaningful impact on the performance of the instant invention. Further, the performance of the instant invention was significantly improved over conventional wet end sizing agents.

### Examples 78-80

This example shows the benefit of the instant invention in laboratory prepared 'bleached board conditions. The studies compare the instant invention to wet-end Rosin sizing.

### Example 78

Laboratory bleached board conditions were simulated using a 1:1 mixture of bleached softwood kraft refined to 420 Canadian Standard Freeness and bleached hardwood kraft refined to 350 Canadian Standard Freeness. No filler was used and the stock pH was adjusted to 4.5. To the stock was added Starch Solution E such that 4 lb/ton of starch was added, 3 lb/ton of anionic polyacrylamide (BAYSTRENGTH® 85 resin), and 1 lb/ton of anionic retention aid.

Handsheets were treated according to Surface Application Procedure C with the emulsion prepared according to Emulsion Procedure A except that 5 parts surfactant D was used, such that the dose was 3 lb/ton of dry fiber. Paper preparation C was utilized.

### Comparative Example 79

Handsheets were prepared according to example 78 except that rosin sizing emulsion at 10 lb/ton and alum at a dose of 20 lb/ton were added prior to the addition of the starch.

### Comparative Example 80

Handsheets were prepared according to example 78 except that rosin sizing emulsion at 10 lb/ton and alum at a dose of 30 lb/ton were added prior to the addition of the starch.

Handsheets from examples 78-80 were tested for sizing using the Cobb test, Test I, and Ultrasonic Attenuation Measurement, MAX value, Test E. These results are reported in Table 13. From these data, we conclude that the instant invention provides equivalent sizing to rosin at a lower dose, and a more water holdout as measured by ultrasonic attenuation modulation.

TABLE 13

| | | Dose | Alum | Cobb | MAX Value |
|---|---|---|---|---|---|
| Example | | (lb/ton) | (lb/ton) | (g/m²) | (sec) |
| 78 | ASA at | 3 | — | 32.5 | 0.79 |
| | surface | | | | |
| Comparative 79 | Rosin | 10 | 20 | 32.5 | 0.23 |
| Comparative 80 | Rosin | 10 | 30 | 33 | 0.17 |

### Example 81

Handsheets were prepared according to Example 78, except that the pH was adjusted to 7.5 with dilute NaOH, calcium carbonate filler (ALBACAR 5970) was added at a dose of 200 lb/ton of dry fiber, and 10 lb/ton or 20 lbs/ton of starch were added.

Handsheets were treated according to Surface Application Procedure C with the emulsion prepared according to Procedure A except that 5 parts of Brij 98 was used, such that the dose level of the size was 2 lb/ton of dry fiber.

### Example 82

Handsheets prepared according to Example 81 were treated according to Surface Application Procedure C such that the dose level of the size was 2.5 lb/ton of dry fiber.

### Example 83

Handsheets prepared according to Example 81 were treated according to Surface Application Procedure C such that the dose level of the size was 3 lb/ton of dry fiber.

### Example 84

Handsheets prepared according to Example 81 were treated according to Surface Application Procedure C such that the dose level of the size was 4 lb/ton of dry fiber.

Handsheets from examples 81-84 were tested for sizing using the Cobb test, Test I. The results are shown in Table 14.

TABLE 14

| | | | Cobb | |
|---|---|---|---|---|
| | | | (gsm) | |
| | | Dose | Starch | Starch |
| Example | | (lb/ton) | (10 lb/ton) | (20 lb/ton) |
| 81 | ASA at surface | 2 | 35 | 36 |
| 82 | ASA at surface | 2.5 | 34 | 35 |
| 83 | ASA at surface | 3 | 33 | 33 |
| 84 | ASA at surface | 4 | 33 | 30 |

From these data we show that the size of this instant invention imparts sizing in filled bleached board grades without the use of rosin or alum.

### Examples 85-90

Examples 85-90 illustrate the sizing efficiency of low shear ASA applied in a size press solution based on starch, polymer or water.

These Examples show the sizing efficiency of sizing compositions having emulsions in a first component made under low shear alkenylsuccinic anhydride applied to a second component that includes size press solution based on starch, polymer or water.

Paper D

Paper D was prepared on a commercial paper machine. The furnish was waste old corrugated container, with a basis weight of 200 g/m². The paper contains 10 weight percent of calcium carbonate and no internal size.

ASA Emulsion C

Total of 10.5 parts of ASA containing 5 wt % Brij 98 surfactant was emulsified with 189.5 parts of water, using a household blender on low speed for 30 second.

### Example 85

Paper D was treated with a mixture of 10.64 parts of ASA Emulsion C and 139.36 parts of the 7-wt % Starch Solution B using Surface Application Procedure A in such a manner that a dose of 2 lb of ASA was added per ton of dry paper fiber.

### Example 86

Paper D was treated with a mixture of 8.18 parts if ASA Emulsion C and 141.82 parts of Treated Water A using Surface Application Procedure A in such a manner that a dose of 2 lb of ASA was added per ton of dry paper fiber.

### Example 87

A 0.1-wt % solution of Baysize® E LS (cationic polyacrylamide, Bayer Chemicals Corporation) was prepared by adding 1.42 parts of the 10-wt % solids polymer to 140.51 parts of Treated Water A.

Paper D was treated with a mixture of 8.07 parts of ASA Emulsion C and 141.93 parts of the 0.1-wt % polymer solution according to Surface Application Procedure A such that a dose of 2 lb of ASA per dry ton of dry paper fiber was added.

### Example 88

A 0.25-wt % solution of Baysize E LS was prepared by adding 3.48 parts of the 10 wt % polymer to 135.88 parts of Treated Water A.

Paper D was treated with a mixture of 10.64 parts of ASA Emulsion C and 139.36 parts of the 0.25-wt % polymer solution according to Surface Application Procedure A such that a dose of 2 lb of ASA per dry ton of dry paper fiber was added.

### Example 89

A 0.1-wt % solution of Baystrength® FP 100 (anionic polyacrylamide, Bayer Chemicals Corporation) was prepared by adding 0.46 part of the 30-wt % solids polymer to 138.84 parts of Treated Water A.

Paper D was treated with a mixture of 10.70 parts of ASA Emulsion C and 139.30 parts of the 0.1-wt % polymer solution using Surface Application Procedure A in such a manner that 2 lb of ASA per ton of dry paper fiber was added.

### Example 90

A 0.25-wt % solution of Baystrength FP 100 was prepared by adding of 1.16 parts of the 30-wt % solids polymer to 138.18 parts of Treated Water A.

Paper D was treated with a mixture of 10.66 parts of Size Emulsion C and 139.34 parts of the 0.25-wt % polymer solution using Surface Application Procedure A in such a manner that 2 lb of ASA per ton of dry paper fiber was added.

The paper treated in Examples 85, 86, 87, 88, 89 and 90 was tested for sizing using the Cobb test, Test I and Ultrasonic Attenuation Measurement, Test E. These results are listed in Table 15.

TABLE 15

| | | PDA A- | Cobb |
|---|---|---|---|
| Example | Type of Size Press Solution | Value | (g/m²) |
| 85 | 7% Starch Solution | 22.2 | 35.5 |
| 86 | Deionized Water | 23.5 | 38.5 |
| 87 | 0.1 wt % Cationic Polymer Solution | 24.9 | 43 |
| 88 | 0.25 wt % Cationic Polymer Solution | 25.7 | 52.5 |
| 89 | 0.1 wt % Anionic Polymer Solution | 23.4 | 35.5 |
| 90 | 0.25 wt % Anionic Polymer Solution | 26.2 | 42.5 |

From these data we show that effective sizing can be achieved when the second component is a starch solution, water, an anionic or a cationic polymer solution.

### Examples 91-94

These Examples showing the influence of hydrolyzed ASA on the instant invention.

An emulsion was prepared with ASA containing 5% Brij 98 surfactant with 8 parts of the sizing surfactant mixture added to 392 parts of untreated water. The emulsion was made in a household blender using the low setting for 30 seconds. The emulsion was then placed in a vessel equipped with an overhead stirrer. The vessel was heated in a water bath maintained at 50° C. Periodically, aliquots were withdrawn and analyzed for anhydride content and surface sizing efficiency. The amount of anhydride in the emulsion was measure using a morpholine titration (ref.: R. B. Wasser, “The Reactivity of Alkenylsuccinic Anhydride: It's Pertinence to Alkaline Sizing,” 1985 Alkaline Papermaking Conference, page 17, TAPPI Press). Surface sizing experiments were conducted according to Surface Treatment Procedure A. The solids content of the aliquot was added to Starch Solution B such that the dose of the size on the treated sheet was 0.5 pounds of size per ton of dry paper. Paper B was treated for the examples.

Every 1.5 hours for 4.5 hours, an aliquot of the initial emulsion that was stirring at 50° C. was removed and tested for % anhydride and particle size (Test F). Sheets were treated as described with the aging emulsion. The resulting sheets were tested for sizing using Test A. Twelve sizing measurements were made on each sheet and averaged. The results are reported in Table 16.

TABLE 16

| | | % Hydrolyzed | Particle | Ink |
|---|---|---|---|---|
| Example | Elapsed Time | ASA | Size | Penetration |
| No. | (hours) | as % of Total | (μ) | (sec) |
| | base sheet | | | 51 |
| | base sheet + starch | | | 75 |
| 91 | 0 | 8.5 | 0.863 | 478 |
| 92 | 1.5 | 28.8 | 1.162 | 430 |
| 93 | 3.0 | 79.7 | 1.207 | 267 |
| 94 | 4.5 | 96.6 | 1.234 | 197 |

These examples illustrate that even though the sizing solution contains hydrolyzed ASA, an effective amount of ink holdout was observed in the sheet. Surprisingly, there was no separation or deposition of the ASA or hydrolyzed ASA in the starch/ASA emulsion. This solution remained stable for several days.

### Examples 95-97

Examples 95, 96, and 97 illustrate the stability of an ASA surfactant mixture, (ASA and 5% Brij® 98, a primary alcohol ethoxylate) which was stored in a 38° C. oven for one month compared to a similar freshly prepared ASA surfactant mixture sample. Emulsion particle size, and ink penetration data are presented.

### Example 95

An emulsion used to make a sizing composition in accordance to the invention was prepared as follows. The emulsion was made by adding 10 parts of ASA containing 5% Brij 98 which was stored for one month in a 38° C. oven to 189.5 parts of water at 25° C. in a household blender and mixing on the low setting for 30 seconds.

### Example 96

An emulsion used to make a sizing composition in accordance to the invention was prepared as follows. The emulsion was made by adding 10 parts of ASA containing 5% Brij 98 which was freshly prepared to 189.5 parts of water at 25° C. in a household blender and mixing on the low setting for 30 seconds.

### Example 97

Sizing emulsions prepared in Examples 95 and 96 were used to size paper by the Surface Application A. Each of the emulsions were separately added to additional Starch Solution B, the second starch component, to make a total sizing composition for paper treatment. To 400 g of Starch Solution B was added 6.31 g of the emulsion. The effectiveness of the sizing was determined by Test A Ink Penetration Holdout described above. Emulsion particle size for each of the emulsions was measured using the Test F Particle Size described above. The results were provided below in Table 17

TABLE 17

| | Ink Penetration | |
|---|---|---|
| Example | (sec) | Particle Size (μ) |
| 95 | 984 | 1.447 |
| 96 | 977 | 1.535 |

This study indicates that the aged ASA sample (Example 95) performs comparably to the freshly prepared sample (Example 96) indicating that the accelerated aging had no affect on the performance of the ASA containing a primary alcohol ethoxylate surfactant based on the particle size of the emulsion or on the ink penetration data.

Although the present invention has been described in detail with reference to certain preferred versions thereof, other variations are possible. Therefore, the spirit and scope of the appended claims should not be limited to the description of the versions contained therein.

What is claimed is:

1. A process for making a sizing composition comprising the steps of:
(a) emulsifying an alkenylsuccinic anhydride component containing (i) alkenylsuccinic anhydride and (ii) a surfactant component, with water; and thereby forming an emulsion; and
(b) combining the emulsion with a second component selected from the group consisting of cationic starches, non-ionic starches, anionic starches, water, water-soluble polymers, and mixtures thereof, thereby forming a sizing composition comprising:
(1) a first component comprising an emulsion having an alkenylsuccinic anhydride component containing alkenylsuccinic anhydride particles and a surfactant component, suspended in water, and
(2) a second component selected from the group consisting of cationic starches, non-ionic starches, anionic starches, water, water-soluble polymers, and mixtures thereof,
wherein the alkenylsuccinic anhydride component and the second component are sufficiently diluted to enable the sizing composition to impart useful sizing properties to a fibrous substrate when the sizing composition contacts the fibrous substrate.

2. The process of claim 1, wherein the surfactant component is selected from the group consisting of sulfosuccinates, alkyl and aryl amides and primary, secondary and tertiary amines and their corresponding quaternary salts fatty acids, ethoxylated fatty acids, fatty alcohols, ethoxylated fatty alcohols, fatty esters, ethoxylated fatty esters, ethoxylated triglycerides, certain ethoxylated lanolin, sulfonated amines, sulfonated amides, ethoxylated polymers, propoxylated polymers, ethoxylated/propoxylated copolymers, polyethylene glycols, phosphate esters, phosphonated fatty acid ethoxylates, phosphonated fatty alcohol ethoxylates, alkyl sulfonates, aryl sulfonates, alkyl sulfates, aryl sulfates, and combinations thereof.

3. The process of claim 1, wherein the surfactant component is present at a level ranging from about 0.1 weight % up to about 20 weight %, based on the alkenylsuccinic anhydride.

4. The process of claim 1, wherein the pressure at which the emulsion is made ranges from about 1 psig to about 150 psig.

5. The process of claim 1, wherein the temperature at which the emulsion is made ranges from more than about 40° F. to about 200° F.

6. The process of claim 1, wherein the emulsion is made with a shearing device having an inlet pressure that is at least about 1 psig to about 5 psig.

7. The process of claim 1, wherein the emulsion is made with a shearing device having an inlet pressure ranging from about 5 psig to about 25 psig.

8. The process of claim 1, wherein the emulsion is made with a shearing device having an outlet pressure ranging from about 15 psig to about 150 psig.

9. The process of claim 1, wherein the emulsion is made with a shearing device having an outlet pressure ranging from about 30 psig to about 100 psig.

10. The process of claim 1, wherein the emulsion is made under shear conditions created by a device selected from the group consisting of centrifugal pumps, static in-line mixers, peristaltic pumps, magnetic stirring bar in a beaker, overhead stirrer, and combinations thereof.

11. The process of claim 1, wherein the temperature at which the emulsion is made is less than about 40° F., the temperature at which the second component ranges from more than about 40° F. to about 200° F., and the emulsion is heated when it is combined with the second component.
